(19) United States
(12) Patent Application Publication
(10) Pub. No.: US 2025/0244751 A1
(43) Pub. Date: Jul. 31, 2025

(54) SMART LOADING OPTIMIZER ENGINE (SLOPE) USING ARTIFICIAL INTELLIGENCE

(71) Applicant: SAUDI ARABIAN OIL COMPANY, Dhahran (SA)

(72) Inventor: Abdullah K. Oraifi, Dammam (SA)

(73) Assignee: SAUDI ARABIAN OIL COMPANY, Dhahran (SA)

(21) Appl. No.: 18/425,406

(22) Filed: Jan. 29, 2024

(51) Int. Cl. G05B 19/418

(52) U.S. Cl. CPC G05B 19/41865; G05B 19/41875; G05B 19/41885

(57) ABSTRACT

A method for optimizing a performance of a processing plant. The method includes obtaining an input flow rate for each input material within a set of input materials received by a processing plant. The processing plant includes one or more material processors connected according to a process flow and outputs a set of output materials. The method further includes determining, using an artificial intelligence (AI) model, a set of process variables, based on the process flow and the input flow rate for each input material within the set of input materials. The set of process variables includes a first output flow rate for a first output material within the set of output materials. The method further includes determining a performance of the processing plant, based on the set of process variables, and optimizing the performance of the processing plant.

### BACKGROUND

Process flow simulation constitutes a challenge for the design and operation of a gas processing plant. While controlling the input flow rates at the entrance of a plant is a simple task, simulating the loading of the interior nodes, or predicting the output flow rates of the plant are much more complex.

Simulation of plant loading is generally performed using software that tries to solve a constrained optimization model. The simulation process is resource intensive. Furthermore, the simulation models have rather low adaptability in the sense that when a process flow changes the simulations have to be re-done.

Accordingly, there is a need to improve (e.g., reduce resource requirements) and automatize the prediction of plant loading.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for optimizing a performance of a processing plant. The method includes obtaining an input flow rate for each input material within a set of input materials received by a processing plant. The processing plant includes one or more material processors connected according to a process flow and outputs a set of output materials. The method further includes determining, using an artificial intelligence (AI) model, a set of process variables, based on the process flow and the input flow rate for each input material within the set of input materials. The set of process variables includes a first output flow rate for a first output material within the set of output materials. The method further includes determining a performance of the processing plant, based on the set of process variables, and optimizing the performance of the processing plant. Optimizing the performance includes increasing the first output flow rate by adjusting the input flow rate for one or more input materials within the set of input materials.

Embodiments disclosed herein generally relate to a system for optimizing a performance of a processing plant. The system includes a process flow and a processing plant, that includes one or more material processors connected by the process flow. The processing plant receives a set of input materials and outputs a set of output materials. The system further includes a computer, configured to receive a plant input flow rate for each input material within a set of input materials and determine, using an artificial intelligence (AI) model, a set of process variables, based on the process flow and the input flow rate for each input material within the set of input materials. The set of process variables includes a first output flow rate for a first output material within the set of output materials. The computer is further configured to determine a performance of the processing plant, based on the set of process variables, and optimize the performance of the processing plant. Optimizing the performance includes increasing the first output flow rate by adjusting the input flow rate for one or more input materials within the set of input materials.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example process flow of a processing plant, in accordance with one or more embodiments disclosed herein.

FIG. 2 depicts an example process flow of a processing plant, in accordance with one or more embodiments disclosed herein.

FIG. 3 depicts an example process flow of a processing plant, in accordance with one or more embodiments disclosed herein.

FIG. 4 depicts an example process flow of a processing plant, in accordance with one or more embodiments disclosed herein.

FIG. 5 depicts an example process flow of a processing plant, in accordance with one or more embodiments disclosed herein.

FIG. 6 depicts an example process flow of a processing plant, in accordance with one or more embodiments disclosed herein.

FIG. 7 depicts a for optimizing a performance of the processing plant, in accordance with one or more embodiments disclosed herein.

FIG. 8 depicts a system for monitoring and optimizing operations of a processing plant, in accordance with one or more embodiments disclosed herein.

FIG. 9 depicts a method for optimizing a performance of a processing plant, in accordance with one or more embodiments disclosed herein.

FIG. 10 depicts an example diagram of a computer, in accordance with one or more embodiments disclosed herein.

FIG. 11 depicts a set of plots, in accordance with one or more embodiments disclosed herein.

FIG. 12A depicts an example result of an AI model, in accordance with one or more embodiments disclosed herein.

FIG. 12B depicts an example result of an AI model, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

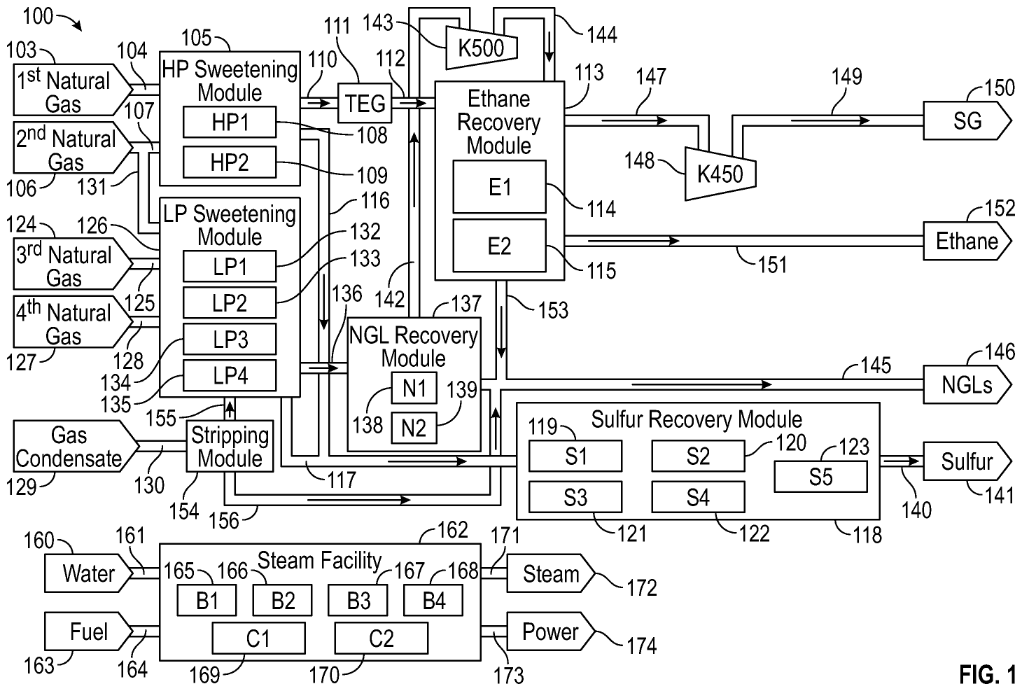

In the following description of FIGS. 1-12B, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

FIG. 1 depicts a process flow of a first example processing plant (100), in accordance with one or more embodiments. In general, processing plants may be configured in a myriad of ways. Therefore, the first example processing plant (100) is used for illustrative purposes and is not intended to be limiting with respect to a particular configuration. The first example processing plant (100) receives a plurality of input materials, such as a first natural gas (103) from a first field. The first example processing plant (100) encompasses a plurality of processing modules, such as a high pressure (HP) sweetening module (105). Each processing module, within the plurality of processing modules, performs one or more specific processes. Each processing module may include one or more material processors. For instance, the HP sweetening module comprises two material processors: a gas sweetener HP1 (108) and a gas sweetener HP2 (109). In instances where a processing module includes only one material processor, the relevant element may be referred to as a material processor or a processing module without undue ambiguity. In some instances, two or more material processors may be referenced individually without reciting a processing module that includes the two or more material processors. The first example processing plant (100) outputs a plurality of output materials, such as sales gas SG (150).

Those skilled in the art will readily appreciate that the processing plant may receive any number of input materials, include any number of processing modules, each processing module containing any number of material processors, and each material processor performing a defined process. Those skilled in the art will further appreciate that the processing plant may output any number of output materials, of any kind. The structure of the first example processing plant (100) may depend on many factors, such as a purpose of the first example processing plant (100), a location of the first example processing plant (100), and a demand for the output materials of the first example processing plant (100). In the depicted example of FIG. 1, the first example processing plant (100) is a gas processing plant. Those skilled in the art will further appreciate that the scope of disclosure extends to other types of processing plants.

The purpose of a processing plant, such as the first example processing plant (100), is to transform the input materials into the output materials using the material processors according to a process flow. In some embodiments, the input materials undergo multiple transformations and mixings through the process flow. In some embodiments, the output materials satisfy a set of quality standards that are not satisfied by the input materials. In other words, in these instances the processing plant, such as the first example processing plant (100), transforms input materials that do not satisfy the set of quality standards into output materials that satisfy the set of quality standards. The set of quality standards may vary, based on, for example, a geographical location. Examples of quality standards within the set of quality standards for a material include, but are not limited to, a range for a caloric value, a maximum water concentration, and a maximum contaminant concentration. For example, as of the date of writing this disclosure, the range for the caloric value of a gaseous hydrocarbon in the United States is 41±5% MJ (megajoules) per cubic meter of gas at a pressure of one atmosphere and a temperature of 15.6 degrees Celsius. To prevent damage to a pipeline, water concentration in a gaseous hydrocarbon should be kept low. In some embodiments, keeping a water concentration low is defined by keeping the water concentration below a maximum water concentration.

For example, at the time of this disclosure, the maximum water concentration for a gaseous hydrocarbon in the United States is 110 mg (milligrams) per cubic meter of gas. Furthermore, the contaminant concentration in a gaseous hydrocarbon should be kept low. In some embodiments, keeping the contaminant concentration low is defined by keeping the contaminant concentration below a maximum contaminant concentration. Examples of contaminants include hydrogen sulfide (H₂S) and carbon dioxide (CO₂). At the time of this disclosure, the maximum H₂S concentration for a gaseous hydrocarbon in the United States is 7 mg per cubic meter of gas. The above examples are provided to demonstrate that desired constraints, such as a maximum level, concentration, or quantity, may be defined according to a given standard. Further, standards may be specific to a country (i.e., a geographical location) where the processing plant is located. That said, constraints need not be set according to a referenced standard. Further, given standards are subject to change (e.g., in accordance with new laws or operating specifications) such that it is emphasized that the above-listed maximum values for caloric value of gaseous hydrocarbon, water concentration, and contaminant concentration are given solely as examples.

The processing plant receives one or more input materials and produces one or more output materials. The one or more materials input into the processing plant undergo one or more transformations by the material processors. In some embodiments, an input material undergoes a plurality of sequential transformations by a sequence of material processors. Each material processor receives one or more input materials. An input material to a material processor is either an input material to the processing plant or an output from a preceding material processor from the process flow. Each material processor produces one or more output materials. An output material from a material processor is either an output material from the processing plant or serves as input to another material processor. Therefore, generally, the materials input to or output from the processing plant may be different from the materials input to or output from a material processor. To ease descriptions in this disclosure, a material input to the processing plant is called a plant input material and is received by the processing plant at a plant input flow rate. A material input to a material processor is called a processor input material and is received by the material processor at a processor input flow rate. A material output from the processing plant is called a plant output material and is produced by the processing plant at a plant output flow rate. A material output from a material processor is called a processor output material and is produced by the material processor at a processor output flow rate.

In the example of FIG. 1, the first example processing plant (100) receives five plant input materials. The five plant input materials received by the first example processing plant (100) are five natural gases. The first example processing plant (100) receives, as input, the first natural gas (103) from the first field. The first example processing plant (100) further receives, as input, a second natural gas (106) from a second field. The first example processing plant (100) further receives, as input, a third natural gas (124) from a third field. The first example processing plant (100) further receives, as input, a fourth natural gas (127) from a fourth field. The first example processing plant (100) further receives, as input, a natural gas condensate (129) from the first field. Like any gas condensate, the gas condensate (Cond) (129) is liquid in ambient conditions at a surface of the earth where it is extracted. In one or more embodiments, the ambient conditions include a temperature and a pressure. Ambient conditions, such as pressure and temperature, can be measured at the processing plant (129) using one or more sensors disposed on or near the processing plant (129).

The first example processing plant (100) produces four plant output materials. The first example processing plant (100) outputs a sales gas (SG) (150). In one or more embodiments, the sales gas (150) includes methane. In one or more embodiments, the sales gas (150) includes methane with a volume concentration of at least 50%. The first example processing plant (100) further outputs ethane (152), sulfur (141), and one or more natural gas liquids (NGLs) (146). Sales gas (150), ethane (152), and NGLs (146) are products obtained from a purification of the plant input materials to the first example processing plant (100). Sulfur (141) is a by-product of the purification. In one or more embodiments, the NGLs (146) include one or more of propane, butanes, pentane, and other hydrocarbons comprising more than five carbon atoms per molecule.

In one or more embodiments, one or more of the first natural gas (103), second natural gas (106), third natural gas (124), fourth natural gas (127) and gas condensate (129) contain hydrogen sulfide (H₂S). A gas with a high concentration of H₂S may be called a sour gas. In some embodiments, a concentration of H₂S is considered as high if it is higher than or equal to a sour concentration threshold, and not high if it is lower than the sour concentration threshold. In the example of FIG. 1, the first example processing plant (100) includes two sweetening modules, namely, the high-pressure (HP) sweetening module (105) and a low-pressure (LP) sweetening module (126), each performing a sweetening process. The sweetening process includes separating acidic gases from a natural gas received as input, the acidic gases comprising H₂S. In some embodiments, the acidic gases further comprise carbon dioxide (CO₂). Examples of a sweetening process include using an amine solvent that dissolves the acidic gases. The products of such a sweetening process are separable and include a sweet gas with a low concentration of acidic gases and an acidic liquid solution with a high concentration of acidic gases. In one or more embodiments, the amine solvent includes diglycolamine. Examples of a sweetening process further include a solid bed process. The solid bed process includes passing an input gas through a solid absorbent material that selectively captures and removes the acidic gases. The products of the solid bed process include a sweet gas with a low concentration of acidic gases. After the solid bed process, the absorbent has a high concentration of acidic gases. Examples of a sweetening process further include a membrane technology. The membrane technology consists of forcing an input gas into a membrane that only allows a passage of the acidic gases. The products of the membrane technology include a sweet gas with a low concentration of acidic gases, that did not pass through the membrane, and the acidic gases, that passed through the membrane. In one or more embodiments, the membrane includes one or more of a polymer and a ceramic.

The HP sweetening module (105) includes one or more material processors such as one or more gas sweeteners. In the specific example of FIG. 1, the HP sweetening module (105) includes two gas sweeteners, called HP gas sweeteners: gas sweetener HP1 (108) and gas sweetener HP2 (109). In other implementations, the HP sweetening module (105) includes only one HP gas sweetener. In other implementations, the HP sweetening module (105) includes more than two HP gas sweeteners. Each of the two gas sweeteners in the HP sweetening module (105) performs a sweetening process, such as the above-mentioned sweetening processes. It is noted that the gas sweeteners HP1 (108) and HP2 (109) perform at a high pressure. The LP sweetening module (126) includes one or more material processors that include one or more gas sweeteners. In the specific example of FIG. 1, the LP sweetening module (126) includes four gas sweeteners, called LP gas sweeteners: gas sweetener LP1 (132), gas sweetener LP2 (133), gas sweetener LP3 (134), and gas sweetener LP4 (135). In other implementations, the LP sweetening module (126) includes less than four LP gas sweeteners. In other implementations, the LP sweetening module (126) includes more than four HP gas sweeteners. Each of the four LP sweeteners (132, 133, 134, 135) in the LP sweetening module (126) performs a sweetening process, such as the above-mentioned sweetening processes. It is noted that the gas sweeteners LP1 (132), LP2 (133), LP3 (134) and LP4 (135) perform at a low pressure. In one or more embodiments, a pressure is considered high if it is higher than or equal to a pre-defined pressure threshold, and low if is it lower than the pressure threshold.

In the example of FIG. 1, the first natural gas (103) is sent to the HP sweetening module (105) through a line (104). Some of the second natural gas (106) is sent to the HP sweetening module (105) through a line (107). The sweet gas output from the HP sweetening module (105), called a HP sweet gas, is sent to a triethylene glycol (TEG) dehydration module (111) though a line (110). In the TEG dehydration module (111), water is removed from the HP sweet gas coming from the line (110). In one or more embodiments, the TEG dehydration module (111) includes an absorption tower. In the absorption tower, water from the HP sweet gas is put into contact and absorbed by triethylene glycol, producing dehydrated sweet gas and water-rich triethylene glycol. The dehydrated sweet gas is sent to an ethane recovery module (113) via a line (112). The water-rich triethylene glycol is heated, which evaporates the water and re-generates triethylene glycol to be used again in the absorption tower of the TEG dehydration module (111). The acidic gases output from the HP sweetening module (105) are passed through a line (116), that connects to a line (117) that leads to a sulfur recovery module (118).

In the example of FIG. 1, the third natural gas (124) is sent to the LP sweetening module (126) through a line (125). The fourth natural gas (127) is sent to the LP sweetening module (126) through a line (128). In some implementations, some of the second natural gas (106) is further sent to the LP sweetening module (126) through a line (131). In these implementations, the second natural gas (106) that is sent to the LP sweetening module (126) is called second natural gas (106) letdown. The gas condensate (129) is sent to a stripping module (154) through a line (130). The stripping module (154) may have various configurations. The stripping module (154) may include one or more of: a compressor; a dehydrator; a high-pressure separator; a low-pressure separator; and a cooler. The stripping module (154) separates NGLs from the input gas condensate (129). The NGLs are passed on to a line (156), that connects to a NGL output line (145) to output the NGLs (146) as one of the plant output materials of the first example processing plant (100). A remaining portion of the gas condensate (129), that is not separated into NGLs, is vaporized as a flash gas. The flash gas flows into the LP sweetening module (126) through a line (155).

The sweet gas output from the LP sweetening module (126), called a LP sweet gas, is sent to a NGL recovery module (137) through a line (136). The NGL recovery module (137) may include one or more material processors. Examples of material processors that may be included in the NGL recovery module (137) include, but are not limited to, a cooler, a dehydrator, a compressor, a distillation column, and a fractionation tower. In the example of FIG. 1, the NGL recovery module (137) includes two material processors: separator N1 (138) and separator N2 (139). In each of the separators N1 (138) and N2 (139), NGLs may be extracted from the LP sweet gas by using a NGL separation process. In some embodiments, the separation process includes a cooling and condensation process. The cooling and condensation process includes cooling the LP sweet gas to a lower temperature, causing the heavier hydrocarbons to condense into a condensed liquid. The separation process may further include a fractionation process. In the fractionation process, the condensed liquid is separated into individual NGL components based on their boiling points. As stated in another paragraph of this disclosure, examples of NGL components include propane, butanes, pentane, and other hydrocarbons comprising more than five carbon atoms per molecule. In some embodiments, the separators N1 (138) and N2 (139) are distillation columns or fractionation towers. The separated NGLs are output to the plant output NGLs (146) through the line (145). A remaining part of the LP sweet gas, that has not been separated into NGL components, is fed into a compressor module K500 (143) through a line (142). The compressor module K500 (143) includes one or more compressors. In one or more embodiments, the one or more compressors within the compressor module K500 (143) are K-500 compressors, as indicated in FIG. 1. The compressor module K500 (143) increases a pressure of the gas received as input, and outputs a compressed sweet gas into an ethane recovery module (113) through a line (144).

The ethane recovery module (113) may include one or more material processors. Examples of material processors that may be included in the ethane recovery module (113) include, but are not limited to, a cooler, a dehydrator, a compressor, a distillation column, and a fractionation tower. In the example of FIG. 1, the ethane recovery module (113) includes two material processors: separator E1 (114) and separator E2 (115). The ethane recovery module (113) receives an input gas composed of the dehydrated gas coming from the TEG dehydration module (111) and compressed sweet gas coming from the compressor module K500 (143). The gas input into the ethane recovery module (113) is separated into ethane, NGLs excluding ethane, and other gases, using a NGL-ethane separation process. Examples of a NGL-ethane separation process that may be performed in each of the separators E1 (114) and E2 (115) include a similar separation process as the one performed in the NGL recovery module (137). In some embodiments, the NGL-ethane separation process includes a cooling and condensation process. The cooling and condensation process includes cooling input gas to a lower temperature, causing the heavier hydrocarbons to condense into a condensed liquid. The separation process may further include a fractionation process. In the fractionation process, the condensed liquid is separated into individual NGL components and ethane based on their boiling points. In some embodiments, the separators E1 (114) and E2 (115) are distillation columns or fractionation towers. The ethane obtained in the ethane recovery module (113) is output from the first example processing plant (100) as the plant output material ethane (152), through a line (151). The separated NGLs, excluding ethane are output, through the line (153), into the line (145) that exits into the NGLs (146). The other gases are output into a compressor module K450 (148) that increases a pressure of the other gases and outputs the sales gases SG (150) though a line (149). The compressor module K450 (148) includes one or more compressors. In one or more embodiments, the one or more compressors within the compressor module K450 (148) are K-450 compressors, as indicated in FIG. 1.

The acidic gases flowing through the line (117) are processed in the sulfur recovery module (118) that includes one or more material processors. In the example of FIG. 1, the sulfur recovery module (118) includes five material processors: sulfur recovery unit (SRU) S1 (119); SRU S2 (120); SRU S3 (121); SRU S4 (122); and SRU S5 (123). In each of the SRUs S1 (119), S2 (120), S3 (121), S4 (122) and S5 (123), sulfur is separated from the acidic gases. The separated sulfur is then output by the first example processing plant (100) as the plant output material sulfur (141) through a line (140). Each of the SRUs S1 (119), S2 (120), S3 (121), S4 (122) and S5 (123) performs a sulfur recovery process. In one or more embodiments, the sulfur recovery process includes a Claus process. The Claus process includes a combustion that transforms H₂S into sulfur dioxide SO₂. The Claus process further includes a catalytic conversion that reacts with additional hydrogen sulfide to form elemental sulfur S₈ and water. The Claus process further includes a condensation of the elemental sulfur S₈ into a liquid. In one or more embodiments, some SO₂ is emitted into the atmosphere as an SO₂ emission.

The processing plant further includes a steam facility (162). The steam facility (162), powered by fuel (163) through a line (164), uses water (160) transmitted through a line (161) to produce processing steam (172) through a line (171). The processing steam (172) may be used to perform one or more processes within the first example processing plant (100). In some embodiments, the processing steam (172) is used in a fractionation tower within the NGL recovery module (137) or the ethane recovery module (113) to heat an input gas mixture to different boiling point of the NGLs included in the input gas mixture. In one or more embodiments, the steam facility (162) includes one of more boilers. In the example in FIG. 1, the steam facility (162) includes four boilers: a boiler B1 (165); a boiler B2 (166); a boiler B3 (167); and a boiler B4 (168). In other implementations, the steam facility (162) can include more or less than four boilers.

In one or more embodiments, the steam facility (162) further includes one or more cogenerators that also produce steam. In the example in FIG. 1, the steam facility (162) includes two cogenerators: cogenerator C1 (169) and cogenerator C2 (170). In other implementations, the steam facility (162) can include more or less than two cogenerators. A notable example of a cogenerator is a heat recovery steam generator (HRSG). Some or all of the steam produced by the cogenerators is used to provide cogenerated power (174) to the first example processing plant (100) through a line (173). In one or more embodiments, the cogenerators include a steam turbine to generate electrical power from the steam produced by the cogenerators, called cogenerated power. Any remaining steam from the cogenerators is then used as processing steam (172), which reduces the burden on the steam boilers. To produce steam, the cogenerators make use of two energy sources: fuel and heat that would otherwise be lost by the first example processing plant (100). Therefore, to produce a given quantity of steam, the cogenerators burn less fuel than the boilers.

Generally, a material processor consumes energy from an energy source to perform a process. In some implementations, a material processor, when not needed, may be turned off and, as such, not consume energy. Furthermore, because of technical limitations, a material processor has a limited capacity to process a processor input material. Such material processors include, but are not limited to, a gas sweetener within the HP sweetening module (105), a gas sweetener within the LP sweetening module (126), a material processor within the stripping module (154), a separator within the NGL recovery module (137), a separator within the ethane recovery module (113), a SRU within the sulfur recovery module (118), a dehydrator from the TEG dehydration module (111), a compressor from the compressor module K500 (143), and a compressor from the compressor module K450 (148). Generally, a material processor can only process a processor input material up to a maximum processor input flow rate and output a processor output material up to a maximum processor output flow rate. Sending a processor input material to a material processor at a material input flow rate above the maximum processor input flow rate creates an overflow into the material processor. In some embodiments, an overflow into the material processor may signal an opportunity loss, by limiting an amount of available processor input material that may otherwise be transformed into a plant output material through the process flow. An alternative to prevent an opportunity loss due to an overflow is presented in other paragraphs of this disclosure. Furthermore, in some embodiments, a material processor can only process a processor input material received at or above a minimum processor input flow rate.

As previously defined, a material input to the processing plant is called a plant input material and is received by the processing plant at a plant input flow rate. A material input to a material processor is called a processor input material and is received by the material processor at a processor input flow rate. In some instances, for example, in the case of a first material processor in a sequence the processing plant, the plant input flow rate and the processor input flow rate (and the plant input material and the processor input material) can be the same. That is, the terms processor input material and processor input flow rate refer to a material and flow rate relative to a given material processor. As such, the processor input material and associated processor input flow rate may reference materials and flow rates that are considered intermediate relative to the processing plant as a whole. The terms plant input material and plant input flow rate refer to a material and flow rate relative to the processing plant. As stated, in some instances, a material processor may receive a plant input material at a plant input flow rate in which case the processor input material and the processor input flow rate are the same as the stated plant input material and plant input flow rate.

A material output from the processing plant is called a plant output material and is produced by the processing plant at a plant output flow rate. A material output from a material processor is called a processor output material and is produced by the material processor at a processor output flow rate. Similarly, the terms processor output material and processor output flow rate refer to a material and flow rate relative to a given material processor. As such, the processor output material and associated processor output flow rate may reference materials and flow rates that are considered intermediate relative to the processing plant as a whole. The terms plant output material and plant output flow rate refer to a material and flow rate relative to the processing plant. As stated, in some instances, a material processor can output a plant output material at a plant output flow rate in which case the processor output material and the processor output flow rate are the same as the stated plant output material and plant output flow rate. In some instances, for example, in the case of a last material processor in a sequence of the processing plant, the plant output flow rate and the processor output flow rate (and the plant output material and the processor output material) can be the same.

As an example, in the first example processing plant (100) of FIG. 1, a sweet gas produced by the gas sweetener HP1 (108) is a processor output material from the gas sweetener HP1 (108) and a processor input material for the TEG dehydration module (111). Similarly, a dehydrated sweet gas from the TEG dehydration module (111) is a processor output material from the TEG dehydration module (111) and a processor input material to at least one of the separators E1 (114) and E2 (115) within the ethane recovery module (113). Generally, a processor input material has already undergone some transformation processes by the processing plant, unless the material processor is an entry material processor. An entry material processor is a material processor that receives a plant input material. In the first example processing plant (100) of FIG. 1, an entry material processor is any material processor within the HP sweetening module (105), the LP sweetening module (126), and the stripping module (154), as they receive at least a plant input material among the first natural gas (103), second natural gas (106), third natural gas (124), fourth natural gas (127), or gas condensate (AA29). Thus, a plant input material is necessarily a processor input material to one or more material processors.

Generally, a processor output material is fed into further material processors to undergo transformations, unless the material processor is an exit material processor. An exit material processor is a material processor that outputs a plant output material. In the first example processing plant (100) of FIG. 1, an exit material processor is any material processor within the compressor module K450 (148), the ethane recovery module (113), the NGL recovery module (137), the stripping module (154), and the sulfur recovery module (118). Thus, a plant output material is necessarily a processor output material from one or more material processors. It is noted that in the first example processing plant (100) of FIG. 1, the stripping module (154) is both an entry material processor and an exit material processor as it receives the gas condensate (129) and outputs some of the NGLs (146).

As stated, elements of this disclosure generally apply to any processing plant. FIG. 1 provides one example of a processing plant but should not be considered as limiting to a particular configuration of a processing plant. In particular, the number of material processors within each processing module may vary. In the first example processing plant (100) of FIG. 1, the HP sweetening module (105) includes the two gas sweeteners HP1 (108) and HP2 (109), the LP sweetening module (126) includes four gas sweeteners LP1 (132), LP2 (133), LP3 (134) and LP4 (135), the ethane recovery module (113) includes the two separators E1 (114) and E2 (EEE15), and the sulfur recovery module (118) includes the five SRUs S1 (119), S2 (120), S3 (121), S4 (122) and S5 (123).

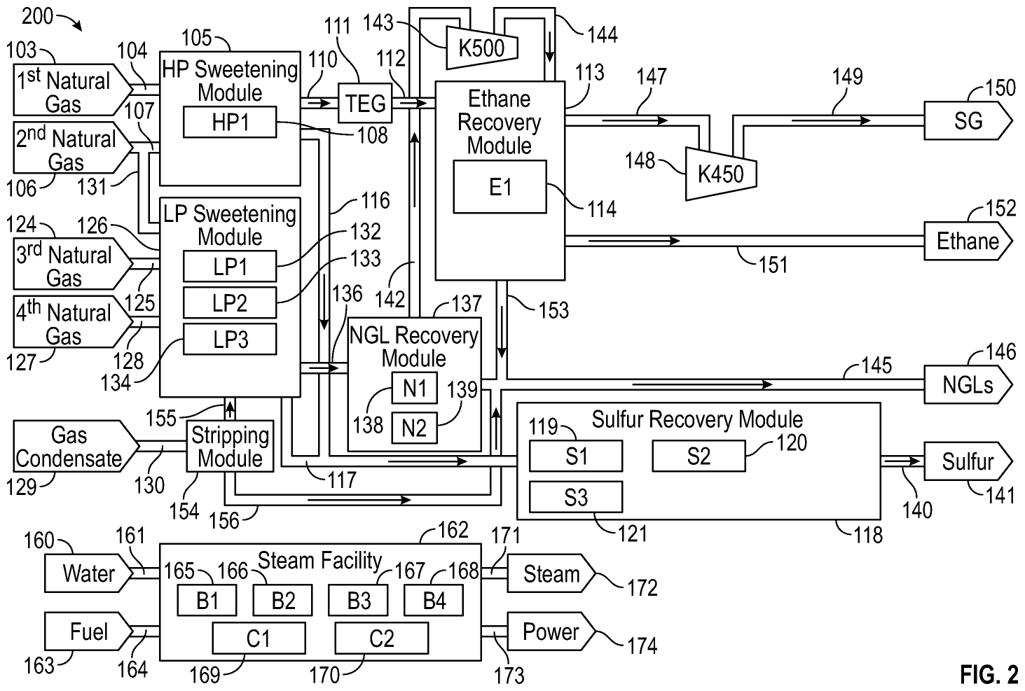

FIG. 2 depicts another example processing plant (or configuration of a processing plant) in accordance with one or more embodiments, referred to as the second example processing plant (200). For concision, a full description of components and/or elements depicted in FIG. 2 is not provided anew for those components and/elements that have be previously described with reference to FIG. 1. The second example processing plant (200) includes the same processing modules as the first example processing plant (100). However, in the second example processing plant (200), the HP sweetening module (105) includes only one gas sweetener HP1 (108), the LP sweetening module (126) includes three gas sweeteners LP1 (132), LP2 (133) and LP3 (134), the ethane recovery module (113) includes only one separator E1 (114), and the sulfur recovery module (118) includes three SRUs S1 (119), S2 (120) and S3 (121).

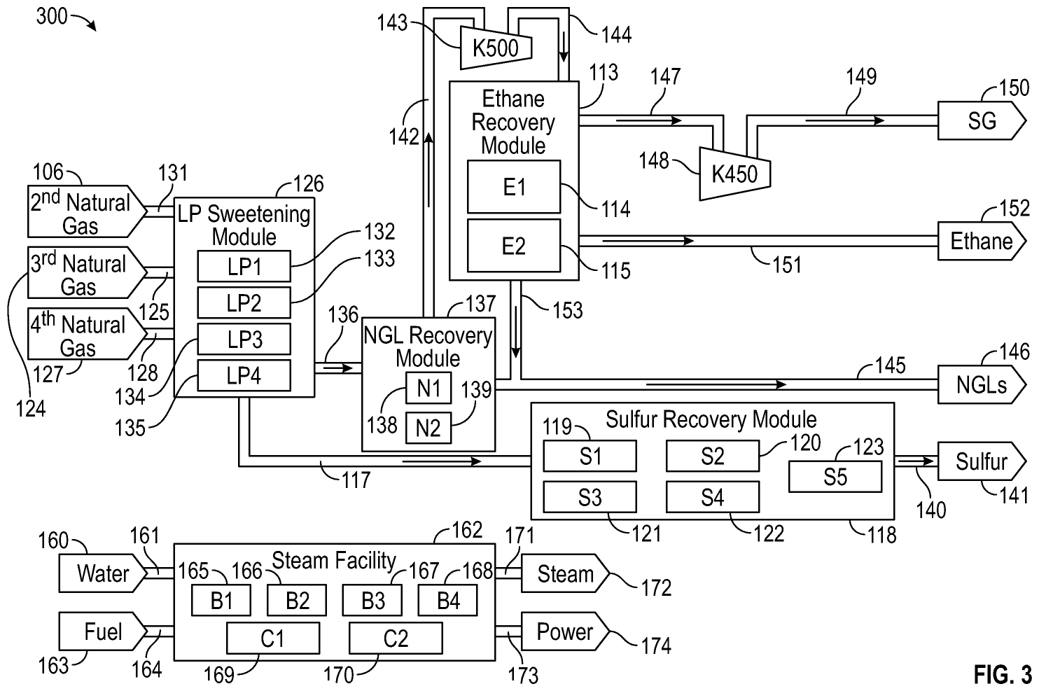

FIG. 3 depicts another example processing plant (or configuration of a processing plant) in accordance with one or more embodiments, referred to as the third example processing plant (300). For concision, a full description of components and/or elements depicted in FIG. 3 is not provided anew for those components and/elements that have be previously described with reference to the preceding figures. The third example processing plant (300) receives the second natural gas (106), third natural gas (124) and fourth natural gas (127) as plant input materials and produces SG (150), ethane (152), sulfur (141) and NGLs (146) as plant output materials. The third example processing plant (300) includes the LP sweetening module (126), the NGL recovery module (137), the compressor module K500 (143), the compressor module K450 (148), the ethane recovery module (113) and the sulfur recovery module (118). Compared to the first and second example processing plants (100, 200), the third example processing plant (300) does not process the first natural gas or the gas condensate. Furthermore, the third example processing plant (300) does not include a HP sweetening module. The three input natural gases (106),(124) and (127) are sent to the LP sweetening module (126) through lines (131), (125) and (128), respectively. The LP sweetening module (126) outputs LP sweet gas that is sent to the NGL recovery module (137) through the line (136). The LP sweetening module (126) further outputs acidic gases, that are sent to the sulfur recovery module (118) through the line (117). The sulfur recovery module (118) outputs sulfur (141) through the line (140). The NGL recovery module (137) produces one or more NGLs that are output as some of the NGLs (146) through the line (145). The NGL recovery module (137) further produces other gases that are sent to the compressor module K500 (143) though the line (142). The compressor module K500 (143) outputs a compressed sweet gas into the ethane recovery module (113) through the line (144). The ethane recovery module (113) outputs ethane (152) through the line (151) and other NGLs as part of the NGLs (146), though the line (153), that connects to the line (145). The ethane recovery module (113) further outputs other gases, that are sent to the compressor module K450 (148) though the line (147). The compressor module K450 (148) outputs SG (150) through the line (149).

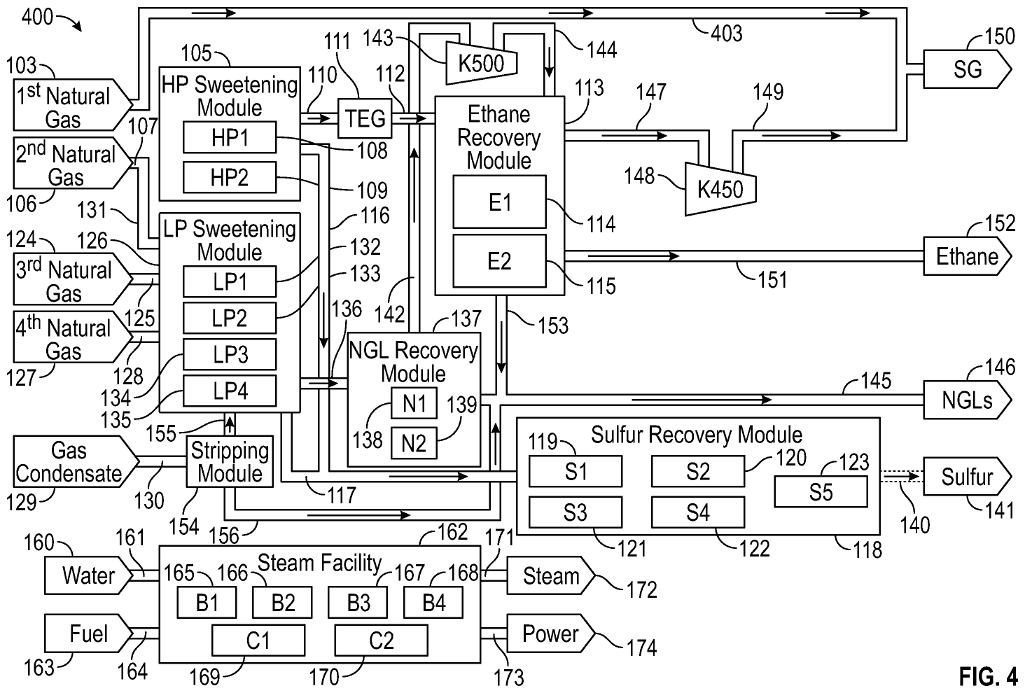

FIG. 4 depicts another example processing plant in accordance with one or more embodiments, referred to as a fourth example processing plant (400). In the fourth example processing plant (400), it is assumed that the HP sweetening module (105) is not functioning and that the first natural gas (103) has a high concentration of sales gas, such as methane, a low concentration of acidic gases, a low concentration of NGLs, and a low concentration of water. In this scenario, the first natural gas (103) is sent directly to the SG (150) through a line (403). In some embodiments, sending the first natural gas (103) directly to the SG (150) is called a diversion from the first natural gas (103) to SG (150). The whole second natural gas (106) is sent to the LP sweetening module (126). The remaining elements and processes of the processing plant (400) function in the same fashion as the first example processing plant (100) in FIG. 1. For concision, a full description of components and/or elements depicted in FIG. 4 is not provided anew for those components and/elements that have be previously described with reference to the preceding figures.

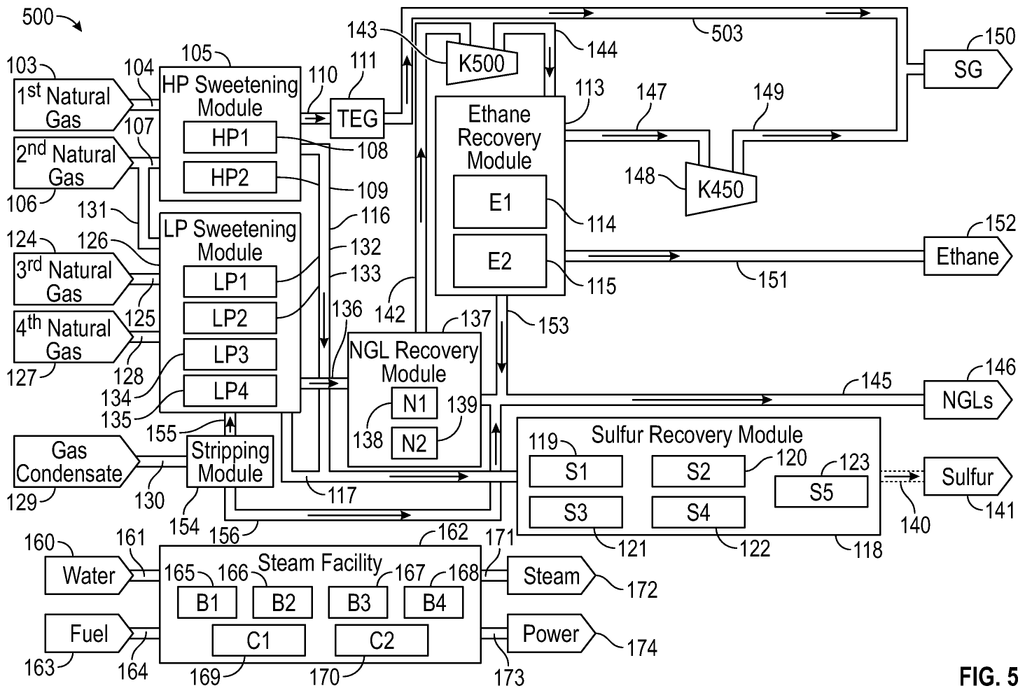

FIG. 5 depicts another example processing plant in accordance with one or more embodiments, referred to as a fifth example processing plant (500). In the fifth example processing plant (500), it is assumed that the first natural gas (103) and second natural gas (106) have a high concentration of sales gases, such as methane, and a low concentration of NGLs. In this scenario, the dehydrated gas output from the TEG dehydration module (111) is sent directly to the SG (150) through a line (503). Thus, in the processing plant (500), the dehydrated gases output from the TEG dehydration module (111) are not sent to the ethane recovery module (113). In some embodiments, sending the output from the TEG dehydration module (111) directly to the SG (150) is called a diversion from the TEG dehydration module (111) to SG (150). The remaining elements and processes of the processing plant (400) function in the same fashion as the first example processing plant (100) in FIG. 1. For concision, a full description of components and/or elements depicted in FIG. 5 is not provided anew for those components and/elements that have be previously described with reference to the preceding figures.

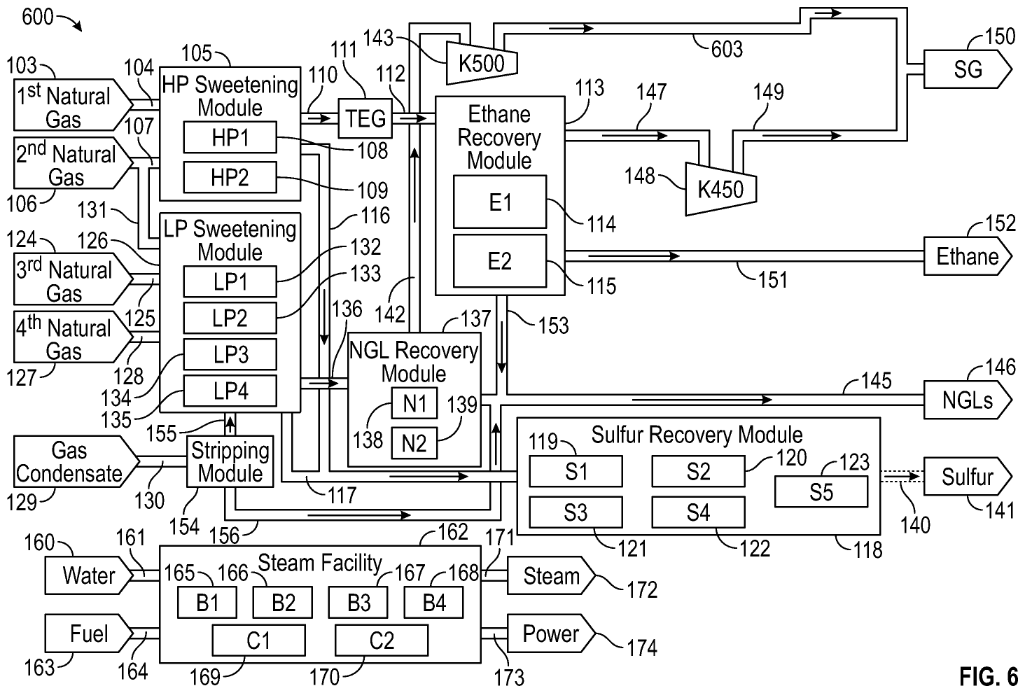

FIG. 6 depicts another example processing plant in accordance with one or more embodiments, referred to as a sixth example processing plant (600). In the sixth example processing plant (600), it is assumed that the gases sent by the NGL recovery module (137) to the compressor module K500 (143) have a low concentration of ethane and NGLs. In this scenario, the compressed gases output from the compressor module K500 (143) are sent directly to the SG (150) through a line (603). Thus, in the sixth example processing plant (600), the compressed gases output from the compressor module K500 (143) are not sent to the ethane recovery module (113). In some embodiments, sending the output from the compressor module K500 (143) directly to the SG (150) is called a diversion from the compressor module K500 (143) to SG (150). The remaining elements and processes of the processing plant (600) function in the same fashion as the first example processing plant (100) in FIG. 1. For concision, a full description of components and/or elements depicted in FIG. 6 is not provided anew for those components and/elements that have be previously described with reference to the preceding figures.

The preceding example processing plants (i.e., first through sixth example gas processing plants (100, 200, 300, 400, 500, 600) need not be separate and/or distinct gas processing plants. In one or more embodiments, a single processing plant may be configured according to any of the configurations depicted by the example processing plants; and other configurations not shown. In accordance with one or more embodiments, the configuration of the processing plant may be adapted, in real time, through alteration of one or more parameters of the processing plant. Parameters may include adjusting the valve state (e.g., open or closed) of one or more valves to direct, redirect, or stop the flow of material to, from, and between various material processors. Additional parameters may include, for example, the state (e.g., on or off) of one or more material processors and/or processor modules. For example, the operation and configuration of a processing plant may be adapted from the first example processing plant (100) to the second example processing plant (200) by turning off, or closing the flow to, select material processors. As will be described in greater detail below, the operation and configuration of a processing plant can be adapted to optimize a performance metric of the processing plant based on, among other things, plant input flow rates.

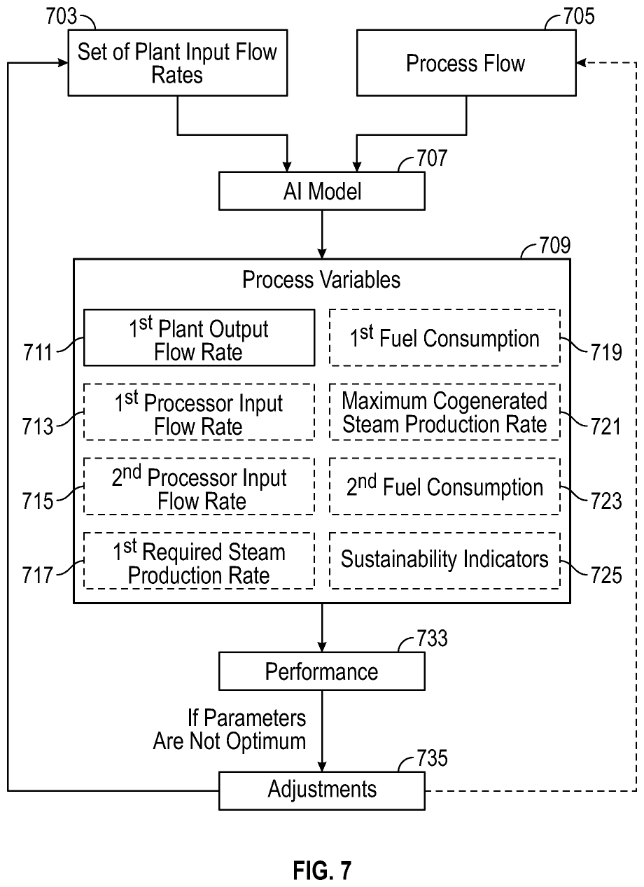

FIG. 7 depicts a system for optimizing a performance (or, more generally, a performance metric) of the processing plant, in accordance with one or more embodiments. As shown in FIGS. 1-6, a processing plant can be operated and configured in a variety of ways. Herein, the operation and configuration of a processing plant is said to be given according to a process flow (705), where the process flow (705) defines, at least, the connection and sequence of material processors to transform a set of plant input materials into a set of plant output materials. For example, in the first example processing plant (100), the plant input materials are the first natural gas (103), second natural gas (106), third natural gas (124), fourth natural gas (127) and gas condensate (129), and the plant output materials are the SG (150), Ethane (152), NGLs (146) and Sulfur (141). In the first example processing plant (100), the process flow includes material processors, such as the sweetening material processor HP1 (108). The process flow further includes the processes performed by the material processors, such as separating hydrogen sulfide (H₂S) from the input materials (103) and (106) in the sweetening material processor HP1 (108). As mentioned in other paragraphs of this disclosure, the system in FIG. 7 may apply to any other processing plant operated by a process flow. Or, in other words, a process flow may define a processing plant according to any of the configurations of FIGS. 1-6, and others not shown, and the system of FIG. 7 is applicable. Further, it is noted that the plant input materials, plant output materials, and configuration of a processing plant need not be as depicted in the first example processing plant (100).

Keeping with FIG. 7, and generalizing to a processing plant configured and/or operated according to a process flow (705), each material within the set of input materials is received by the processing plant with a plant input flow rate, forming a set of plant input flow rates (703). In accordance with one or more embodiments, the set of plant input flow rates (703) and process flow (705) are sent to an artificial intelligence (AI) model (707). The AI model (707) predicts a set of process variables (709) that includes, at least, a first plant output flow rate (711) for a first plant output material. In some embodiments, the AI model (707) further outputs a second plant output flow rate for a second plant output material. Applied to the first example processing plant (100), the first plant output flow rate (711) may be a plant output flow rate for the SG (150), Ethane (152), the NGLs (146), or the sulfur (141). In some embodiments, the AI model (707) may output an output flow rate for two or more of the SG (150), Ethane (152), the NGLs (146), or the sulfur (141).

In one or more embodiments, the AI model (707) includes a regression model. Examples of regression models that may be included in the AI model (707) include a polynomial fit. In a polynomial fit, the first output flow rate (711) is expressed as a polynomial with respect to the set of plant input flow rates (703). An example of a polynomial fit is a second order polynomial fit, in which the polynomial is quadratic. In some implementations, the AI model (707) includes multiple, distinct regression models each distinct regression model predicting a plant output flow rate for a distinct plant output material withing within the set of plant output materials. An example of such implementation is given for the first example processing plant (100). In the first example processing plant (100), the first natural gas (103) is received with a plant input flow rate of X¹ and distributed into the gas sweeteners HP1 (108) and HP2 (109) according to the process flow (705). Similarly, the second natural gas (106) is received with a plant input flow rate of X² and distributed into the gas sweeteners HP1 (108), HP2 (109), LP1 (132), LP2 (133), LP3 (134) and LP4 (135) by the process flow (705). The third natural gas (124) is received with a plant input flow rate of X³ and the fourth natural gas (127) are received with plant input flow rates X³ and X⁴, respectively, and distributed into the gas sweeteners LP1 (132), LP2 (133), LP3 (134) and LP4 (135) by the process flow (705). The gas condensate (129) is received with a plant input flow rate of X⁵ and fed into the stripping module (154) by the process flow (705). Denoting Y¹ as the SG (150) plant output flow rate, Y² as the Ethane (152) plant output flow rate, Y³ as the NGLs (146) plant output flow rate and Y⁴ as the Sulfur (141) pant output flow rate, the AI model (707) may include one or more of the following four second order polynomial fits:

$${Y}^{1} = {α}^{1} + {\sum }_{k = 1}^{k = 5} {β}^{1 , j} {X}^{j} + {\sum }_{j = 1}^{j = 5} {\sum }_{k = 1}^{k = 5} {γ}^{1 , j , k} {X}^{j} {X}^{k} , \qquad EQ . 1$$

$${Y}^{2} = {α}^{2} + {\sum }_{k = 1}^{k = 5} {β}^{2 , j} {X}^{j} + {\sum }_{j = 1}^{j = 5} {\sum }_{k = 1}^{k = 5} {γ}^{2 , j , k} {X}^{j} {X}^{k} , \qquad EQ . 2$$

$${Y}^{3} = {α}^{3} + {\sum }_{k = 1}^{k = 5} {β}^{3 , j} {X}^{j} + {\sum }_{j = 1}^{j = 5} {\sum }_{k = 1}^{k = 5} {γ}^{3 , j , k} {X}^{j} {X}^{k} , \qquad EQ . 3$$

$${Y}^{4} = {α}^{4} + {\sum }_{k = 1}^{k = 5} {β}^{4 , j} {X}^{j} + {\sum }_{j = 1}^{j = 5} {\sum }_{k = 1}^{k = 5} {γ}^{4 , j , k} {X}^{j} {X}^{k} . \qquad EQ . 4$$

In EQ. 1-EQ. 4, the coefficients α^{l}, β^{l,j} and γ^{l,j,k} for l=1, . . . , 4, j=1, . . . , 5 and k=1, . . . , 5 are real parameters determined upon training the AI model (707).

In one or more embodiments, the process variables (709), output by the AI model (707), further include a first processor input flow rate (713) into a first material processor. In the context of the first example processing plant (100), examples for the first processor input flow rate (713) include a processor input flow rate of the first natural gas (103) into the gas sweetener HP1 (108), a processor input flow rate of an acid gas into the SRU S1 (119), a processor input flow rate of an acid gas into the SRU S2 (120) and a processor input flow rate of an output gas from the NGL recovery module (137) into a first K-500 compressor within the compressor module K500 (143). As an example, the AI model may include a distinct regression model that predicts a processor input flow rate of a gas into a first compressor within the compressor module K500 (143). An example of such a distinct regression model is a second order polynomial fit that expresses the processor input flow rate of a gas into the first compressor within the compressor module K500 (143), denoted as Y⁵, as a second order polynomial with respect to one or more plant input flow rates within the set of plant input flow rates (703). As an example, the one or more plant input flow rates are selected as the plant input flow rates X², X³, X⁴, and X⁵ for the second natural gas (106), third natural gas (124), fourth natural gas (127) or gas condensate (AA29) respectively. The second order polynomial fit that expresses the processor input flow rate of a gas into the first compressor within the compressor module K500 (143) is defined as:

$${Y}^{5} = {α}^{5} + {\sum }_{k = 2}^{k = 5} {β}^{5 , j} {X}^{j} + {\sum }_{j = 2}^{j = 5} {\sum }_{k = 2}^{k = 5} {γ}^{5 , j , k} {X}^{j} {X}^{k} . \qquad EQ . 5$$

In EQ. 5, the coefficients α⁵, β^{5,j} and γ^{5,j,k}, for j=2, . . . , 5 and k=2, . . . , 5 are real parameters that are determined upon training the AI model (707).

In some embodiments, the process variables (709), output by the AI model (707), further include a second processor input flow rate (715) into a second material processor. The second material processor is different from the first material processor. For instance, in the context of the first example processing plant (100), the first material processor may be the gas sweetener HP1 (108) while the second material processor may be the gas sweetener HP1 (109). As another example, the first material processor may be the first compressor within the compressor module K500 (143) while the second material processor may be a second compressor within the compressor module K500 (143). As another example, the first material processor may be the gas sweetener HP1 (108) while the second material processor may be the first compressor within the compressor module K500 (143). In some embodiments, the AI model may include a distinct regression model, such as a second order polynomial fit, that predicts the second processor input flow rate (715) as a function of the set of plant input flow rates (703). Following this concept, it is noted that the system in FIG. 7 includes scenarios in which further processor input flow rates, other than the first processor input flow rate (713) and the second processor input flow rate (715), are included in the process variables (709). In some embodiments, the AI model (707) predicts a processor input flow rate into each material processor of the processing plant.

In one or more embodiments, one or more processes performed by the processing plant make use of processing steam, such as the processing steam (172) in the first example processing plant (100). For instance, a fractionation tower, which could be the separator N1 (138), uses steam to lead a mixture to different boiling points of its components. In some embodiments, the process variables (709) further include a first required steam production rate (717). The first required steam production rate (717) is defined by the processing steam needed by the processing plant to perform all the processes that need steam, in accordance with the process flow (705). Given the plant input flow rates X¹ for the first natural gas (103), X² for the second natural gas (106), X³ for the third natural gas (124), X⁴ for the fourth natural gas (127) and X⁵ for the gas condensate (129) the AI model (707) may further include a distinct regression model that predicts the first required steam production rate (717), denoted as Y⁶. This distinct regression model may also be a second order polynomial fit:

$${Y}^{6} = {α}^{6} + {\sum }_{k = 1}^{k = 5} {β}^{6 , j} {X}^{j} + {\sum }_{j = 1}^{j = 5} {\sum }_{k = 1}^{k = 5} {γ}^{6 , j , k} {X}^{j} {X}^{k} . \qquad EQ . 6$$

In EQ. 6, the coefficients α⁶, β^{6,j} and γ^{6,j,k}, for j=1, . . . , 5 and k=1, . . . , 5 are real parameters that are determined upon training the AI model (707).

In one or more embodiments, the processing plant includes a steam facility that produces the processing steam to be used by the processes consuming steam. The processing steam is produced by heating water by burning fuel. An example of such a steam facility is the steam facility (162) of the first example processing plant (100). The steam facility (162) produces processing steam (172) by heating water (160) by burning fuel (163). In some implementations, the AI model (707) further predicts a first fuel consumption (719) required by the steam facility to produce processing steam at a rate called a first steam production rate. The first fuel consumption (719) is then included in the process variables (709). The AI model may include a distinct regression model that predicts the first fuel consumption (719) from the first steam production rate. An example of such a distinct regression model, that predicts the first fuel consumption (719) from the first steam production rate, is a second order polynomial fit that expresses the first fuel consumption (719), denoted as Y⁷, as a second order polynomial with respect to the first steam production rate, denoted as X⁶:

$${Y}^{7} = {α}^{7} + {β}^{7 , 6} {X}^{6} + {γ}^{7 , 6 , 6} {X}^{6} \cdot {X}^{6} . \qquad EQ . 7$$

In EQ. 7, the coefficients α⁷, β^{7,6} and γ^{7,6,6} are real parameters that are determined upon training the AI model (707). In one or more embodiments, the first steam production rate is set to the first required steam production rate (717). In such scenarios, the first steam production rate X⁶ may be replaced, in EQ. 7, with the first required steam production rate (717) obtained in EQ. 6, denoted by Y⁶. The polynomial fit in EQ. 7 then reads:

$${Y}^{7} = {α}^{7} + {β}^{7 , 6} {Y}^{6} + {γ}^{7 , 6 , 6} {Y}^{6} \cdot {Y}^{6} . \qquad EQ . 8$$

In one or more embodiments, the steam facility further includes one or more cogenerators that also produce steam, called cogenerated steam. The cogenerated steam is produced at a rate called a cogenerated steam production rate. As described in other paragraphs of this disclosure, the steam produced by the cogenerators is used to generate cogenerated power, used by the pant at utility power. If the cogenerators produce enough steam for the cogenerated power to meet the utility power, any excess cogenerated steam is used as processing steam, in an effort to reduce a usage of the steam boilers. Using processing steam produced by the cogenerators is preferred over processing steam produced by the steam boilers as the cogenerators burn less fuel in comparison with the boilers. A reason why the cogenerators burn less fuel in comparison with the steam boilers is because the cogenerators further use, as an energy source, heat that would otherwise be lost by the processing plant. As an example, the first example processing plant (100) includes the cogenerator C1 (169) and the cogenerator C2 (170) within the steam facility (162). The cogenerators C1 (169) and C2 (170) produce steam that is transformed into the cogenerated power (174). Any steam left after producing the cogenerated power (174) is transferred to the processing steam (172). In one or more embodiments, the AI model (707) further predicts a maximum cogenerated steam production rate (721) included in the process variables (709). The maximum cogenerated steam production rate (721) is a maximum steam production rate produced by the cogenerators from the heat generated by the processing plant upon processing the plant input materials at the set of plant input flow rates (703). In that respect, the AI model (707) may further include a distinct regression model that predicts the maximum cogenerated steam production rate (721), denoted Y⁸, as a function of the plant input flow rates X¹ the first natural gas (103), X² for the second natural gas (106), X³ for the third natural gas (124), X⁴ for the fourth natural gas (127) and X⁵ for the gas condensate (129). In some implementations, the regression model that predicts the maximum cogenerated steam production rate (721) is a second order polynomial fit:

$${Y}^{8} = {α}^{8} + {\sum }_{k = 1}^{k = 5} {β}^{8 , j} {X}^{j} + {\sum }_{j = 1}^{j = 5} {\sum }_{k = 1}^{k = 5} {γ}^{8 , j , k} {X}^{j} {X}^{k} . \qquad EQ . 9$$

In EQ. 9, the coefficients α⁸, β^{8,j} and γ^{8,j,k}, for j=1, . . . , 5 and k=1, . . . , 5 are real parameters determined upon training the AI model (707).

In one or more embodiments, the AI model (707) further predicts a second fuel consumption (723) that is consumed by the cogenerator to produce steam at a given cogenerated steam production rate. The second fuel consumption (723) is included in the process variables (709). The AI model may include a distinct regression model that predicts the second fuel consumption (723) from the cogenerated steam production rate. An example of such a distinct regression model, that predicts the second fuel consumption (723) from the cogenerated steam production rate, is a second order polynomial fit that expresses the second fuel consumption (723), denoted as Y⁹, as a second order polynomial with respect to the cogenerated steam production rate, denoted as X⁷:

$${Y}^{9} = {α}^{9} + {β}^{9 , 7} {X}^{7} + {γ}^{9 , 7 , 7} {X}^{7} \cdot {X}^{7} . \qquad EQ . 10$$

In EQ. 10, the coefficients α⁹, β^{9,7} and γ^{9,7,7} are real parameters that are determined upon training the AI model (707). In one or more embodiments, the cogenerated steam production rate is set to the maximum cogenerated steam production rate (721). In such scenarios, the cogenerated steam production rate (721) X⁷ may be replace, in EQ. 10, with the maximum cogenerated steam production rate (721) obtained in EQ. 10, denoted by Y⁸. The polynomial fit in EQ. 10 then reads:

$${Y}^{9} = {α}^{9} + {β}^{9 , 7} {X}^{7} + {γ}^{9 , 7 , 7} {Y}^{8} \cdot {Y}^{8} . \qquad EQ . 11$$

Based on the process variables (709) predicted by the AI model (707), a performance (733) is determined for the processing plant. Then, a determination is made whether the performance (733) is optimum. If the performance (733) is optimum, the processing plant continues operating according to the set of plant input flow rates (703) and the process flow (705). If the performance (733) is not optimum, adjustments (735) to the set of plant input flow rates (703) are determined in order to optimize the performance (733). In one or more embodiments, the adjustments (735) further include one or more process flow adjustments, to be made to the process flow (705). The adjustments (735) are implemented to the processing plant. The processing plant continues operating according to the adjusted plant input flow rates, that become the set of plant input flow rates (703). If the adjustments (735) further include one or more process flow adjustments, the processing plant continues operating according to the adjusted process flow, that becomes the process flow (705). In other words, the adjustments (735) may include adjusting the plant input flow rates and or the operation and configuration of the processing plant through the alteration of one or more parameters of the processing plant such as valve states.

In one or more embodiments, the performance (733) includes the first plant output flow rate (711). In such a scenario, it may be desirable for the plant to maximize the first plant output flow rate (711). The performance (733) may be considered as optimum if the first plant output flow rate (711) is greater than a target flow rate threshold. If the performance (733) is not optimum, the set of plant input flow rates (703) may be adjusted to obtain a first plant output flow rate (711) greater than the target flow rate. An example technique to determine what adjustments (735) may be made to the set of plant input flow rates (703) is a grid search technique. To perform a grid search technique, denote {Xᵢ, 1≤i≤N} as the set of plant input flow rates (703), where N≥1 is the number of plant input flow rates within the set of plant input flow rates (703), i is an integer, and each Xᵢ is an input flow rate, for each integer i such that 1≤i≤N. Then, a feasible range Rᵢ is defined for each Xᵢ, for i such that 1≤i≤N. Then, for each feasible range Rᵢ, a certain integer number Kᵢ≥1 of values for the input flow rates, Xᵢ^{k}, 1≤k≤Kᵢ are taken on each feasible range Rᵢ, resulting in a Πᵢ₌₁^{N} Kᵢ-dimensional grid X of input flow rate values. For each set \hat{X} of flow rate values on the grid X, a first output flow rate G(\hat{X}) is determined, and the set of plant input flow rates (703) are set to input flow rate values \hat{X}* such that for all \hat{X}ϵX, G(\hat{X}*)≥G(\hat{X}). Therefore, using this technique, adjusting the set of plant input flow rates (703) to be the input flow rate values \hat{X}* maximizes the first output flow rate on the grid X. In one or more embodiments, a feasible range Rᵢ for an input flow rate Xᵢ, is determined by a material processor's capacity. A first plant input material with a flow rate Xᵢ is fed to the processing plant into a first material processor such as, for example, a gas sweetener. The first material processor may only be able to process the first plant input material with a processor input flow rate above a minimum processor input flow rate and below a maximum processor input flow rate. In such scenario, a feasible range Rᵢ, for an input flow rate Xᵢ, may be defined as an interval bounded by the minimum processor input flow rate and the maximum processor input flow rate. For instance, in the example of the first example processing plant (100), the input first natural gas (103) is fed into, at least, the gas sweetener HP1 (108). In one or more embodiments, the gas sweetener HP1 (108) has a minimum processor input flow rate of 150 million standard cubic feet per day (MMSCFD) and a maximum processor input flow rate of 360 MMSCFD. Therefore, a feasible range for the processor input flow rate for the first natural gas (103) into the first example processing plant (100) through the gas sweetener HP1 (108) is [150,360].

As stated, a first material processor can only receive the first processor input material below a first maximum processor input flow rate. If the first processor input material is received by the first material processor at a first processor input flow rate above the first maximum processor input flow rate, there is an overflow of the first processor input material into the first material processor. In some embodiments, an overflow of the first processor input material may signal an opportunity loss, by limiting an amount of available first processor input material that may otherwise be transformed into a plant output material through the process flow. In some embodiments, an overflow further leads to a material damage, resulting in a temporary shut down of the first material processor and a reduction of a plant output flow rate. In one or more embodiments, the first processor input flow rate (711) is predicted to be greater than the first maximum processor input flow rate, resulting in an overflow into the first material processor.

In some embodiments, the performance (733) is not optimum due to the overflow. The performance (733) may be optimized by using a process flow adjustment to prevent the overflow. First, an overflowed first input flow rate is computed as a difference between the first processor input flow rate (713) and the first maximum processor input flow rate. Next, assume that the second material processor can receive the first processor input material and perform a same process as the first material processor. The second material has a second maximum processor input flow rate. A first availability is computed, for the second material processor, as a difference between the second maximum processor input flow rate and the second processor input flow rate (715). If the first availability is positive, a process flow adjustment, called a diversion, may be made, as part of the adjustments (735), to optimize the performance (733). The process flow adjustment consists of diverting some, or all of the overflowed first input flow rate from the first material processor to the second material processor. The amount of overflowed first input flow rate diverted from the first material processor to the second material processor is called a first diverted input flow rate. The first diverted input flow rate is less than or equal to the first availability. The process flow adjustment reduces the overflowed first input flow rate by the first diverted input flow rate. In some embodiments, the first availability is greater than or equal to the overflowed first input flow rate. In these scenarios, the whole overflowed first input flow rate may be diverted to the second material processor, preventing the overflow into the first material processor. In some embodiments, a third processor input flow rate, into a third material processor, is computed by the AI model (707). The third material processor has a third maximum processor input flow rate and may receive the first processor input material and perform the same process as the first material processor. A second availability is computed, for the third material processor, as a difference between the third maximum processor input flow rate and the third processor input flow rate. If the second availability is positive, the process flow adjustment may further include diverting some of the overflowed first input flow rate from the first material processor to the third material processor. The amount of overflowed first input flow rate diverted from the first material processor to the third material processor is called a second diverted input flow rate. The second diverted input flow rate is less than or equal to the second availability. The process flow adjustment reduces the overflowed first input flow rate by the sum of the first diverted input flow rate and the second diverted input flow rate. Those skilled in the art will readily appreciate that the process flow adjustment described herein further extends to diverting the overflowed first input flow rate to three or more other material processors. In some scenarios, such process flow adjustment may lead to an increase of the first plant output flow rate (711), thus increasing the performance (733).

An example of such a diversion is described herein for the first example processing plant (100). In this example, it is assumed that the gas sweeteners HP1 (108) and HP2 (109) each have a maximum processor input flow rate of 360 MMSCFD. It is further assumed that the AI model (707) predicts processor input flow rates of 360 MMSCFD for the first natural gas (103) into the gas sweetener HP1 (108), 40 MMSCFD of first natural gas (103) into the gas sweetener HP2 (109), and 400 MMSCFD of second natural gas (106) into the gas sweetener HP2 (109). Therefore, there is an overflowed input flow rate of 80 MMSCFS into the gas sweetener HP2 (109). It is further assumed that the gas sweeteners within the LP sweetening module (126), namely, LP1 (132), LP2 (133), LP3 (134) and LP4 (135) each have a maximum processor input flow rate of 180 MMSCFD. It is further assumed that the AI model (707) further predicts processor input flow rates of 150 MMSCDF into each of the gas sweeteners LP1 (132), LP2 (133), LP3 (134) and LP4 (135). A first availability of 30 MMSCFD is computed as 180 MMSCFD-150 MMSCFD for the gas sweetener LP1 (132). Similarly, a second, third and fourth availabilities of 30 MMSCFD are computed for the gas sweeteners LP2 (133), LP3 (134) and LP4 (135) respectively. Then, the overflowed input flow rate of 80 MMSCFS of second natural gas (106) may be diverted from the gas sweetener HP2 (109) into the LP sweetening module (126) in several ways through the line (131), preventing the 80 MMSCFD overflow into the gas sweetener HP2 (109). In one scenario, 20 MMSCFD of second natural gas (106) are diverted from the gas sweetener HP2 (109) to each of the four gas sweeteners LP1 (132), LP2 (133), LP3 (134) and LP4 (135). In another scenario, 30 MMSCFD of second natural gas (106) are diverted from the gas sweetener HP2 (109) to the gas sweetener LP1 (132), 30 MMSCFD of second natural gas (106) are diverted from the gas sweetener HP2 (109) to the gas sweetener LP2 (133) and 20 MMSCFD of second natural gas (106) are diverted from the gas sweetener HP2 (109) to the gas sweetener LP3 (134). Those skilled in the art will appreciate that the overflowed input flow rate may be diverted and distributed to the four gas sweeteners LP1 (132), LP2 (133), LP3 (134) and LP4 (135) in any combination that totals 80 MMSCFD.

In one or more embodiments, the performance (733) further depends on an energy consumption by the processing plant. As described in other paragraphs of this disclosure, any given material processor consumes energy from an energy source to perform a process. The adjustments (735) may include turning a material processor off, when not needed, to reduce the energy consumption, therefore optimizing the performance (733). Assume that the AI model (707) outputs a processor input flow rate for a plurality of materials that perform a same process, the plurality of material processors composed of the first material processor and a set of one or more additional material processors that include the second material processor. A first availability is computed, for the second material processor, as a difference between the second maximum processor input flow rate and the second processor input flow rate (715). Similarly, assuming that the set of one or more additional material processors includes P material processors Mᵢ, for i=1, . . . , P, a i^{th} availability, Aᵢ, is computed for the i^{th} material processor for all i=1, . . . , P, as a difference between a i^{th} maximum processor input flow rate for the i^{th} material processor Mᵢ and a i^{th} processor input flow rate for the i^{th} material processor Mᵢ. If the sum of the availabilities Σᵢ₌₁^{i=P} Aᵢ is less than the first processor input flow rate (711), the first processor input flow rate (711) can be diverted from the first input material to the set of one or more additional material processors. The first material processor is then turned off, reducing the energy consumption of the processing plant. In some embodiments, the set of one or more additional material processors is composed of the second material processor only and the first processor input flow rate (711) is diverted from the first material processor to the second material processor.

An example is given herein for the first example processing plant (100). Assume that the AI model (707) predicts that the gas sweetener HP1 (108) receives an input flow rate of 100 MMSCFD for the first natural gas (103), the gas sweetener HP1 (108) receives an input flow rate of 50 MMSCFD for the second natural gas (106), and the gas sweetener HP2 (109) receives an input flow rate of 100 MMSCFD for the second natural gas (106). The total input flow rate for the HP sweetening module (105) is then 250 MMSCFS. If the material processors HP1 (108) and HP2 (109) each have a maximum input flow rate of 360 MMSCFD, the total input flow rate for the HP sweetening module (105) can be handled by only one of the material processors HP1 (108) and HP2 (109) alone. In this case, the energy consumption may be reduced in at least two ways. As a first example, the 100 MMSCFD for the first natural gas (103) and the 50 MMSCFD of second natural gas (106) input to gas sweetener HP1 (108) are diverted to the gas sweetener HP2 (109). Then, the gas sweetener HP1 (108) is turned off, reducing the energy consumption of the first example processing plant (100). As a second example, the 100 MMSCFD for the second natural gas (106) input to the gas sweetener HP2 (109) are diverted to the gas sweetener HP1 (108). Then, the gas sweetener HP2 (109) is turned off, reducing the energy consumption of the first example processing plant (100). The adjustments (735) include the process flow adjustment consisting of turning off the material processors HP1 (108) or HP2 (109). The processing plant continues operating with the adjusted process flow, that becomes the process flow (705). That is, the process flow (705) represents and/or defines a new configuration and/or operation of the processing plant.

In one or more embodiments, the processing plant includes the steam facility that produces processing steam and the performance (733) further depends on a fuel consumption by the steam facility. The higher the fuel consumption by the steam facility, the lower the performance (733). It is assumed that the fuel consumption by the steam facility increases with the first steam production rate. In some embodiments, the steam facility does not include cogenerators and the fuel consumed by the steam facility is consumed by the boilers. In these scenarios, the first fuel consumption (719) is computed, using the AI model (707), as the fuel necessary to produce the first steam production at the first required production rate (717). In some implementation, this computation of the first fuel consumption (719) is done by computing the first required production rate (717) using EQ. 6 and then computing the corresponding first fuel consumption (719) using EQ. 8. Then, the determination whether the performance (733) is optimum includes comparing the fuel consumption by the steam facility with the first fuel consumption (719). If the fuel consumption by the steam facility is greater than the first fuel consumption (719), the performance (733) is considered not optimal. Since the fuel consumption by the steam facility increases with the first steam production rate, the fact that the fuel consumption by the steam facility is greater than the first fuel consumption (719) implies that the first steam production rate is greater than the first required steam production rate (717). In this scenario, too much processing steam is produced by the steam facility. In such a case, a possible way of optimizing the performance (733) is to reduce the first steam production rate to be equal to the first required steam production rate (717), which reduces the fuel consumption by the steam facility. Denoting the first steam production rate as S₁ and the first required steam production rate (717) as R₁, this way of optimizing the performance (733) is done by setting S₁=R₁. By setting S₁=R₁ the fuel consumption by the steam facility is capped by the first fuel consumption (719). In some embodiments, optimization of the performance (733) of a processing plant includes, or is performed through, the application of constraints to an optimization process or routine, such as the equality constraint S₁=R₁. Other constraints may be similarly applied, such as an inequality constraint that enforces a flow rate to be above or below a given minimum or maximum value, respectively.

In other embodiments, the steam facility further includes one or more cogenerators that also produce steam, called cogenerated steam. As stated in other paragraphs of this disclosure, the cogenerators make use of two energy sources: fuel and heat that would otherwise be lost by the processing plant. The cogenerators consume less fuel than the boilers to produce a given quantity of steam. Therefore, to minimize the quantity of fuel consumed by the steam facility, the production of steam by the cogenerators is maximized and prioritized over the production of steam by the boilers. The cogenerated steam is produced at a cogenerated steam production rate, denoted as S2. Some, or all of the cogenerated steam is used to provide cogenerated power to the processing plant. Any remaining cogenerated steam is then used as processing steam in an effort to reduce S₁, which in turn reduces the fuel consumption of the processing plant. In some embodiments, the fuel consumption of the processing plant is minimized as follows. A utility power, required by the processing plant, is determined. A second required steam production rate, denoted as R₂, is evaluated, defined as a cogenerated steam production rate that would be necessary for the cogenerators to produce cogenerated power equal to the utility power. In other words, if the cogenerated production rate is greater than or equal to the second required steam production rate, the cogenerators produce enough power for the processing plant. The maximum cogenerated steam production rate (721), computed by the AI model (707), is denoted as Mₐ. Then, the fuel consumption by the steam facility is minimized under the three following scenarios listed herein as scenario (a), scenario (b), and scenario (c). In scenario (a), Mₐ≤R₂ and the cogenerators are configured to produce steam at their maximum capacity and the boilers are configured to produce cogenerated steam at the first required steam production rate (717); that is, S₂=Mₐ and S₁=R₁. In this case, all the cogenerated steam is used to generate power to the processing plant and all the processing steam is produced by the boilers. In scenario (b), R₂<Mₐ<R₁+R₂ and the cogenerators are still configured to produce cogenerated steam at their maximum capacity, but the surplus Mₐ−R₂ is used as processing steam to fulfill some of R₁. This reduces the burden on the boilers and in turn, reduces the fuel consumption of the processing plant. In this case, S₂=Mₐ and S₁=R₁+R₂−Mₐ. The utility power is entirely produced by the cogenerators and the processing steam is produced in part by the boilers and in part by the cogenerators. In scenario (c), Mₐ≥R₁+R₂ and the cogenerators are configured to produce below their maximum capacity, and produce both the utility power and the processing steam entirely; that is, S₂=R₁+R₂. In this case, the boilers may be turned off.

Once the cogenerated steam production rate S2 is computed, the second fuel consumption (723) is computed using the AI model (707). In some implementations, this computation of the second fuel consumption (723) is done by using the second order polynomial fit in EQ. 10. Then, the determination whether the performance (733) is optimum includes comparing the fuel consumption by the cogenerators with the second fuel consumption (723). If the fuel consumption by the cogenerators is greater than the second fuel consumption (723), the performance (733) is considered not optimum. Since the fuel consumption by cogenerators increases with the cogenerated production rate, the fact that the fuel consumption by the cogenerators is greater than the second fuel consumption (723) implies that the current cogenerated steam production rate is greater than S₂ and that too much steam is produced by the cogenerators. In this scenario, a possible way of optimizing the performance (733) is to reduce cogenerated steam production rate to S2. As described above, this optimization may be performed though the use of a constraint (e.g., equality constraint or inequality constraint) on the cogenerated steam production rate.

In one or more embodiments, the performance (733) includes a revenue generated through use of or by the processing plant. The revenue is based on a cost of the plant input materials, a cost of the energy used by the processing plant, a cost of the fuel consumed by the processing facility, and a revenue from the plant output materials. The revenue increases with an increase of the plant output flow rates and with a decrease of the cost of the plant input materials, the energy used by the processing plant, and the fuel consumed by the steam facility. In these embodiments, the adjustments (735) described in other paragraphs of this disclosure may optimize the performance (733). For instance, any adjustment to the set of plant input flow rates (703) that results in an increase of the first plant output flow rate (711) also increases the revenue of the processing plant. As another example, shutting down a material processor without reducing plant output flow rates results in an increase of the revenue of the processing plant by reducing the operating costs of the processing plant.

In further embodiments, the AI model (707) further outputs sustainability indicators (725) that may be used to monitor the processing plant. Examples for the sustainability indicators (725) include a maximum cogenerated power. The maximum cogenerated power is defined as the cogenerated power produced by the cogenerators when the cogenerators are configured to produce cogenerated steam at the maximum cogenerated steam production rate (721). Examples for the sustainability indicators (725) further include a sulfur dioxide (SO₂) emission by the processing plant into the atmosphere. The SO₂ emission is a by-product of the sulfur recovery module (118). In one or more embodiments, a high level of SO₂ emission, defined as a SO₂ emission above a maximum SO₂ emission threshold, may indicate a malfunction of a SRU within the sulfur recovery module (118).

As stated, the process variables (709) are computed using the AI model (707). Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, regression models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture”. Once an AI model type and hyperparameters have been selected, the AI model is trained to perform a task. A notable example of an AI model that may be used as AI model (707) is a regression model. A cursory introduction to a regression model is provided herein. However, it is noted that many variations of a regression model exist, and many methods for training a regression model may be used. Furthermore, many examples of a regression model exist, in addition to the examples provided herein. Therefore, one with ordinary skill in the art will recognize that any variation of the regression model (or any other AI model), the training method used, and the examples provided herein may be employed without departing from the scope of this disclosure. Further, it is emphasized that the following discussions of a regression model is a basic summary and should not be considered limiting.

Let (Xᵢ, Yⱼ), for i=1, . . . , N, be a dataset of training examples, for N≥2, each training example including an input Xᵢϵ [symbol] ^{K} and an associated output Yᵢϵ [symbol] ^{D}. A regression model is built as a functional mapping that optimally matches the inputs of the training examples to the associated outputs of the training examples. Let F: [symbol] ^{K}× [symbol] ^{M}→ [symbol] ^{D}, be a pre-defined function that associates a value F(X, α)ϵ [symbol] ^{D} to a variable Xϵ [symbol] ^{K} and a parameter αϵ [symbol] ^{M} Given a parameter αϵ [symbol] ^{M}, a mathematical distance L: [symbol] ^{D}× [symbol] ^{D}→ [symbol] and an index i, a term F(Xᵢ, α) is said to be an approximation of Yᵢ with an error of Eᵢ(α)=L(F(Xᵢ, α), Yᵢ), that measures how close F(Xᵢ, α) is to Yᵢ. An example of mathematical distance L is a square of a l₂ norm of a difference, namely, L(F(Xᵢ, α), Yᵢ)=∥F(Xᵢ, α)−Yᵢ∥ₗ_{₂}². A global error function E: [symbol] ^{M}− [symbol] is defined as

$$E ( α ) = \frac{1}{N} {\sum }_{i = 1}^{i = N} L ( F ( {X}_{i} , α ) , {Y}_{i} ) . \qquad EQ . 12$$

A regression model is defined as a function

$$\hat{F} : X ∈ {ℝ}^{K} \to \hat{F} ( X ) := F ( X , \hat{α} ) ∈ {ℝ}^{D} , \qquad EQ . 13$$

where \hat{α}ϵ [symbol] ^{M} is an optimal parameter such that the global error E(\hat{α}) is optimally small. A notable example of such a parameter, \hat{α}, is a solution to an iterative solver that seeks a solution α* to the following minimization problem:

$$find {α}^{★} ∈ {ℝ}^{M} such that for all α ∈ {ℝ}^{M} , E ( {α}^{★} ) \leq E ( α ) . \qquad EQ . 14$$

Finding \hat{α} is called training the regression model from EQ. 13. A notable example of a regression model in EQ. 13 is a linear regression model. A linear regression model is a function \hat{F} satisfying EQ. 13 and such that for all X ϵ [symbol] ^{K}, α→F(X, α) is linear. In other words, A linear regression model is a function \hat{F} satisfying EQ. 13 and such that there exists a sequence of M basis functions φⱼ: [symbol] ^{K}→ [symbol] ^{D}, for j=1, . . . , M, such that for all Xϵ [symbol] ^{K}, αϵ [symbol] ^{M},

$$F ( X , α ) = ( {φ}_{1} ( X ) , … , {φ}_{M} ( X ) ) \cdot α . \qquad EQ . 15$$

Examples of linear regression models include a linear fit. A linear fit is a linear regression model in which the functions φⱼ in EQ. 15 are affine with respect to X for j=1, . . . , M. Examples of linear regression models further include a polynomial fit. A polynomial fit is a linear regression model in which the functions φⱼ in EQ. 15 are polynomial with respect to X for j=1, . . . , M. A regression model that is not linear is called a non-linear regression model. Examples of non-linear regression models include a logistic regression model, in which

$$F ( X , α ) = \frac{1}{1 + exp ( - ( {φ}_{1} ( X ) , ... , {φ}_{M} ( X ) ) \cdot α )} ,$$

where the M basis functions φⱼ: [symbol] ^{K}→ [symbol] ^{D}, j=1, . . . , M, are affine. Examples of non-linear regression models further include neural networks, such as deep neural networks (DNN), convolutional neural network (CNN) and recurrent neural networks (RNN).

Finding a parameter α* that satisfies EQ. 14 is only possible in rare cases, for instance, in cases for which the gradient ∇E can be computed, the equation ∇E(α)=0 can be solved for α, and it can be shown that at least one solution, denoted by α*, thus satisfying ∇G(α*)=0, also satisfies EQ. 14. In such scenarios, the optimal parameter \hat{α} is the solution α* to EQ. 14. Generally, the optimization problem in EQ. 14 is solved in an approximate sense, by iterating an algorithm, called an optimizer, until a certain convergence criterion is reached. In one or more embodiments, the optimizer is a gradient descent method. Given an initial parameter α⁰ϵ [symbol] ^{M}, the optimizer produces a recurrent sequence, indexed by an integer iteration number q≥1, of parameters α^{q}ϵ [symbol] ^{M} such that α^{q} only depends on the values of the parameters α^{s}, for s<q. In one or more embodiments, the parameter α⁰ may be defined randomly. In one or more embodiments, the optimizer is defined such that the parameter α^{q}, at each iteration q, only depends on set the values of α^{q-1}. Intuitively, the goal of the optimizer is that the error function E, applied to one of the terms of the sequence α^{q} at an iteration q*, namely, E(α^{q*}) is as small as possible. In one or more embodiments, the optimizer is defined such that the sequence E(α^{q}) is a decreasing sequence and then, iterating the optimizer always produces a parameter α^{q} associated with a smaller error than the previous error, E(α^{q-1}). The optimizer runs for a certain number of iterations, Q≥1, called the maximum iteration number. In one or more embodiments, the maximum iteration number Q is pre-defined and the convergence criterion for the iterative optimizer is that the iteration number be Q. The convergence criterion for the optimizer can be defined in many other ways. In other embodiments, the convergence criterion is noting that the distance |E(α^{q})−E(α^{q-1}) is less than a predefined threshold for a certain q≥1. If a convergence criterion is met at a certain iteration, the optimizer is said to have converged, and the iterative process stops. Regardless of the definition of the convergence criterion, the maximum iteration number is reached when the convergence criterion is met and denoted as Q. An optimal parameter can then be defined in many ways. In one or more embodiments, the optimal parameter is defined as \hat{α}=α^{Q}, that is, the last value obtained by the optimizer when the convergence criterion is met. In other embodiments, the optimal parameter \hat{α} is defined as a parameter \hat{α}=α^{q*}, for some integer q* such that 0≤q*≤Q, that minimizes the error in the following sense: for all q such that 0≤q≤Q, E(α^{q*})≤E(α^{q}).

To train the AI model (707), a plurality of input-target pairs, called examples, is needed, forming a dataset of examples. An example, within the plurality of examples, includes an input and an associated output (or target). In the context of the AI model (707), an input is a set of plant input flow rates for the processing plant, and an output is a set of process variables obtained by the processing plant when submitted to the input. To obtain the examples, a set of experiments may be run. Each experiment, within the set of experiments, consists of processing plant input materials with a set of plant input flow rates, defining an input, and assessing values for the process variables obtained by such processing. The assessed values for the process variables define the associated output. In the example of the first example processing plant (100), if the process variables are composed of plant output flow rates for the SG (150), ethane (152), sulfur (141) and NGLs (146), an experiment consists of processing the first natural gas (103), second natural gas (106), third natural gas (124), fourth natural gas (127) and gas condensate (129) with given plant input flow rates and measuring the plant output flow rates for the SG (150), ethane (152), sulfur (141) and NGLs (146). The AI model (707) may include several machine learning models, each machine learning model predicting one or more process variables within the set of process variables. A notable embodiment described in this disclosure, for the AI model (707), is a set of second order polynomial fits including at least EQ. 1. In some embodiments, depending on which process variables are of interest, the set of second order polynomial fits may further include one or more of EQ. 2-EQ. 11. Furthermore, the AI model (707) further receives, as input, the process flow (705). As described, the process flow (705) may vary. Examples of alterations of the process flow (705) include a process flow adjustment, as part of the process flow adjustments (735), performed to optimize the performance (733). Examples of process flow adjustments include turning of a material processor to reduce the energy consumption of the processing plant. Examples of alterations of the process flow (705) further include a diversion, such as a diversion from the TEG dehydration module (111) to SG (150) in the processing plant (500). In some embodiments, a diversion is performed to bypass a piece of equipment, such as material processor, while the piece of equipment is undergoing maintenance or repair. Alterations of the process flow (705), such as a diversion, may be implemented through adjustments to the states of one or more valves of the processing plant (e.g., valve adjusted to an “open” or “closed” state). In some implementations, the AI model (707) can include machine learning models for each variation of the process flow (705).

Generally, the dataset of examples is split into a training dataset and a testing dataset. The example input and associated output pairs of the training dataset are called training examples. The example input and associated output pairs of the testing dataset are called testing examples. It is common practice to split the dataset in a way that the training dataset contains more examples than the testing dataset. Because data splitting is a common practice when training and testing a machine-learned model, it is not described in detail in this disclosure. One with ordinary skill in the art will recognize that any data splitting technique may be applied to the dataset without departing from the scope of this disclosure. Once trained, the AI model is validated by computing a metric for the testing examples, in accordance with one or more embodiments. Examples of metrics that may be used to validate the AI model include any scoring or comparison function known in the art, including but not limited to: a mean square error (MSE), a root mean square error (RMSE), and a coefficient of determination (R²), respectively defined as:

$$MSE = \frac{1}{n} {\sum }_{i = 1}^{i = n} {\vert {\hat{y}}_{i} - {y}_{i} \vert}^{2} , \qquad EQ . 16$$

$$RMSE = \sqrt{\frac{1}{n} {\sum }_{i = 1}^{i = n} {\vert {\hat{y}}_{i} - {y}_{i} \vert}^{2}} , \qquad EQ . 17$$

$${R}^{2} = 1 - \frac{{\sum }_{i = 1}^{i = n} {\vert {\hat{y}}_{i} - {y}_{i} \vert}^{2}}{{\sum }_{i = 1}^{i = n} {\vert {y}_{i} - \overline{y} \vert}^{2}} . \qquad EQ . 18$$

In EQ. 16, EQ. 17, and EQ. 18, n denotes the number of testing examples, each training example being defined as an input-output pair, (xᵢ, yᵢ), for i=1, . . . , n, in which xᵢ is the input, yᵢ is the output associated with xᵢ,

$$\overline{y} = \frac{1}{n} {\sum }_{i = 1}^{i = n} {y}_{i} ,$$

and ŷᵢ denotes the prediction obtained by inputting xᵢ into the AI model, for i=1, . . . , n. The notation |⋅| denotes a norm that can be applied to the object in between. For example, if the outputs are real-valued, the notation |⋅| may denote an absolute value. If the outputs are vector-valued, the notation |⋅| may denote an l₂ norm.

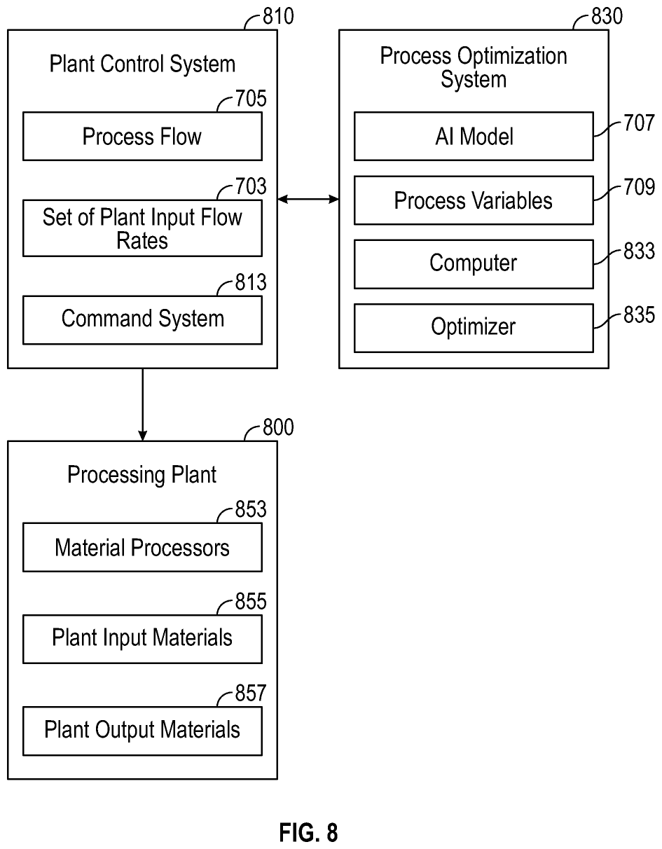

FIG. 8 depicts a system for monitoring and optimizing operations of a processing plant, in accordance with one or more embodiments. The system in FIG. 8 includes a processing plant (800), a plant control system (810), and a process optimization system (830). The processing plant (800) includes one or more material processors (853) that transform plant input materials (855) into plant output materials (857). An example for the processing plant (800) is the first example processing plant (100). The first example processing plant (100) has five plant input materials (855), namely, the first natural gas (103), second natural gas (106), third natural gas (124), fourth natural gas (127) and gas condensate (129). The first example processing plant (100) has four plant output materials (857), namely, the SG (150), ethane (152), NGLs (146) and sulfur (141). The first example processing plant (100) includes a plurality of material processors (853), such as, for example, the gas sweetener LP1 (132) and the SRU S1 (119).

The plant (800) is operated according to the process flow (705) included in the plant control system (810). The process flow (705) connects the material processors (853) by distributing processor input materials and processor output materials to the material processors (853), resulting in transforming the plant input materials (855) into the plant output materials (857). The plant control system (810) further includes a set of plant input flow rates (703). The set of plant input flow rates (703) and the process flow (705) can be set and tuned by a command system (813). The command system implements the set of plant input flow rates (703) and the process flow (705) to the processing plant (800). Setting or tuning the set of plant input flow rates (703) and the process flow (705) influences the operations of the processing plant (800). For instance, the plant output flow rates of the plant output materials may be altered if there is a change in the set of plant input flow rates (703) or the process flow (705). In some embodiments, increasing one or more plant input flow rates within the set of plant input flow rates (703) may increase a plant output flow rate of one or more plant output materials. However, the material processors (853) have a maximum capacity to process processor input materials. Therefore, increasing one or more plant input flow rates within the set of plant input flow rates (703) may lead to an overflow into a first material processor within the material processors (853). In such a scenario, the first material processor will process at, but not above, its maximum capacity. In this situation, the processing plant (800) is said to be saturated. If the processing plant (800) is saturated, further increasing one or more plant input flow rates within the set of plant input flow rates (703) may not result in an increase of a plant output flow rate of one or more plant input materials.

The process optimization system (830) includes the AI model (707). As stated in the description of FIG. 7, the AI model (707) receives, as input, the set of plant input flow rates (703) and the process flow (705). The AI model (707) returns, as output, the process variables (709). The process variables (709) include, at least, a prediction for the first plant output flow rate (711). In one or more embodiments, the process variables (709) further include the first processor input flow rate (713), the second processor input flow rate (715), the first fuel consumption (719), the second fuel consumption (723), the maximum cogenerated steam production rate (721), or any combination thereof. The AI model (707) is hosted and run on a computer (833). Based on the process variables (709) predicted by the AI model (707), adjustments (735) to the set of plant input flow rates (703) and/or the process flow (705) are determined by an optimizer (835) to optimize a performance of the processing plant (800). Examples of adjustments determined by the optimizer (835) to optimize the performance (733) are described as the adjustments (735) in FIG. 7. The adjustments determined by the optimizer (835) are sent to the plant control system (810) and implemented to the processing plant (800) by the command system (813).

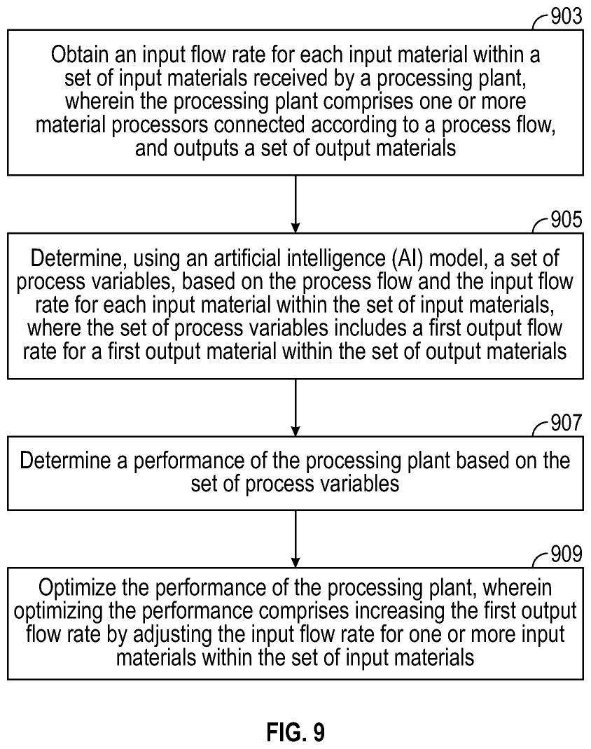

FIG. 9 depicts a method for optimizing a performance of a processing plant, in accordance with one or more embodiments. A processing plant, such as the first example processing plant (100), receives a set of plant input materials as input and outputs a set of output materials. The processing plant includes one or more material processors. As an example, the first example processing plant (100) receives five plant input materials (855) as input, namely, the first natural gas (103), second natural gas (106), third natural gas (124), fourth natural gas (127) and gas condensate (129). The first example processing plant (100) outputs four plant output materials (857), namely, the SG (150), ethane (152), NGLs (146) and sulfur (141). The first example processing plant (100) includes a plurality of material processors, such as, for example, the gas sweetener LP1 (132) and the SRU S1 (119). The material processors transform the plant input materials into the plant output materials though a process flow, such as the process flow (705). In Step 903, a plant input flow rate is obtained for each input material within the set of plant input materials.

In Step 905, a first plant output flow rate is determined for a first output material within the set of plant output materials. The determination of the first plant output flow rate is done by using an artificial intelligence (AI) model, that receives as input, the process flow and the plant input flow rate for each input material within the set of plant input materials. In one or more embodiments, the AI model in Step 905 is similar to the AI model (707) in the system in FIG. 7 and may include a regression model. As an example, EQ. 1 presents a second order polynomial fit that predicts the plant output flow rate Y¹ for the output material sales gas SG (150) in the first example processing plant (100). The second order polynomial fit in EQ. 1 receives, as inputs, the plant input flow rates X¹, X², X³, X⁴ and X⁵ for the first natural gas (103), second natural gas (106), third natural gas (124), fourth natural gas (127) and gas condensate (129), respectively.

In Step 907, a performance is determined for the processing plant, based on, at least, the first plant output flow rate from Step 905. The performance may be determined in many ways. Example of a performance in Step 907 include the examples described for the performance (733) in FIG. 7. In some embodiments, the performance in Step 907 is the first plant output flow rate from Step 905. In other embodiments, the performance in Step 907 further includes an energy consumption by the processing plant. In further embodiments, the performance in Step 907 further includes a fuel consumption by a steam facility included in the processing plant.

In Step 909, the performance from Step 907 is optimized by adjusting, at least, the plant input flow rate for one or more plant input materials within the set of plant input materials. It is noted that adjusting a plant input flow rate for a plant input material may influence the first plant output flow rate through the process flow. As described in the system in FIG. 7, optimizing the performance may include other actions. In one or more embodiments, optimizing the performance includes reducing the energy consumption of the processing plant by shutting down a first material processor, and diverting the processor input flow rate for the from the first material processor to a set of other material processors.

In one or more embodiments, the processing plant requires steam to function, and includes, for that purpose, a steam facility. The steam facility produces steam, called processing steam, to be used by some of the processes of the processing plant. Examples of processes that need processing steam to function include a fractionation tower, in which the temperature is brought up boiling points of components of a gas mixture. The temperature is brought up using steam. Generally, the steam facility receives water and fuel as input. The fuel is burned to heat the water, producing processing steam. The more the processing steam produced, the more fuel is necessary. As an example, the first example processing plant (100) includes the steam facility (162), that includes the four boilers B1 (165), (166), (167) and (168). The steam facility (162) burns fuel (163) to heat water (160) and produce the processing steam (172). In some implementations, the AI model further returns, in Step 905, a first required steam production rate, necessary to process the plant input materials at the plant input flow rates from Step 903. In these implementations, the AI model may further produce a fuel consumption by the steam boiler facility to produce steam at the predicted steam production rate. In some embodiments, the performance in Step 907 is further based on the fuel consumption of the steam boiler facility, and optimizing the performance in Step 909 further includes making sure that no steam is produce beyond the predicted steam production rate. Ensuring that no steam is produced beyond the predicted steam production rate minimizes fuel consumption. If steam is produced beyond the predicted steam production rate, the optimization in Step 909 is done by reducing the steam production rate to the first required steam production rate.

It is noted that the method in FIG. 9 extends to a plurality of output materials. In that regard, Step 905 may further include obtaining a second output flow rate for a second output material within the set of output materials. Accordingly, the performance in Step 907 may further be based on the second output flow rate.

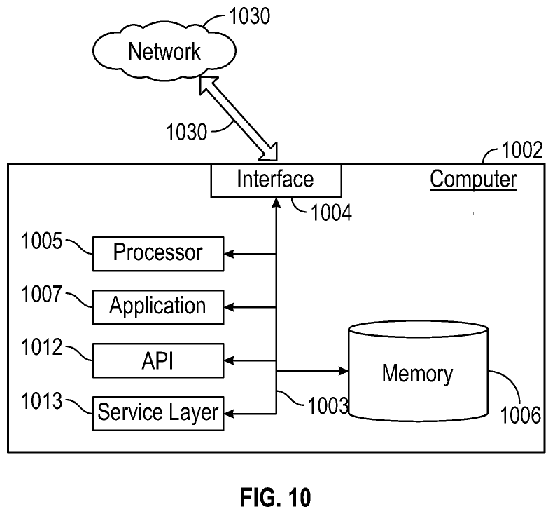

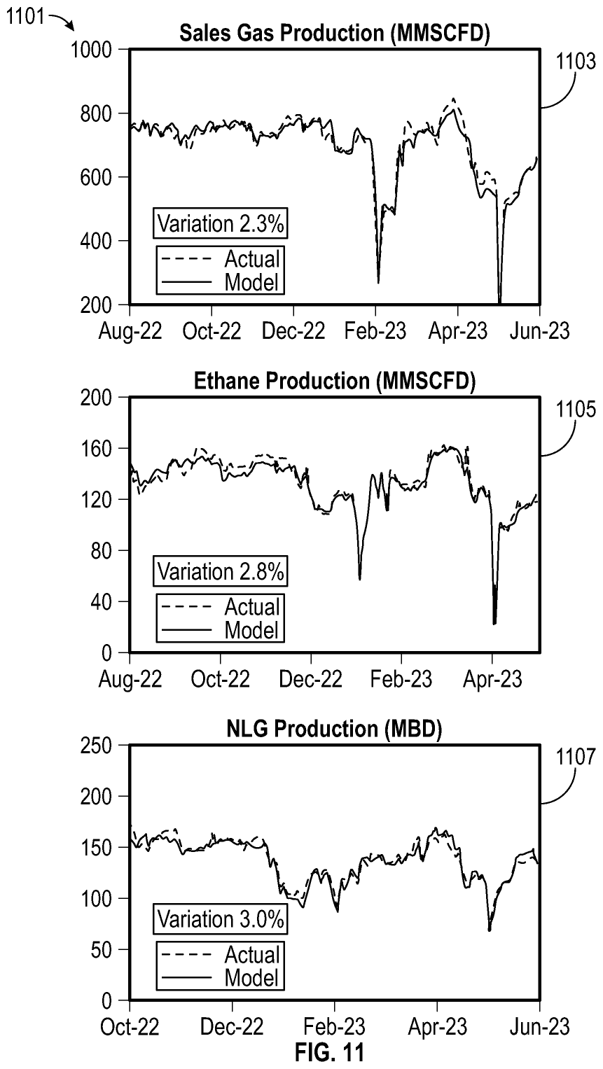

The computations mentioned in this disclosure may be performed by a computer, such as the computer (833) in FIG. 8. In that regard, FIG. 10 depicts a block diagram of a computer (1002) used to provide computational functionalities associated with described algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environments (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers such as the computer (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers such as the computer (1002).

### EXAMPLES

The following examples are provided for the benefit of a reader and should not be interpreted as limiting the scope of the present disclosure. In some instances, the examples may be considered as merely illustrative and may not provide an exhaustive description of a processing plant or its operation.

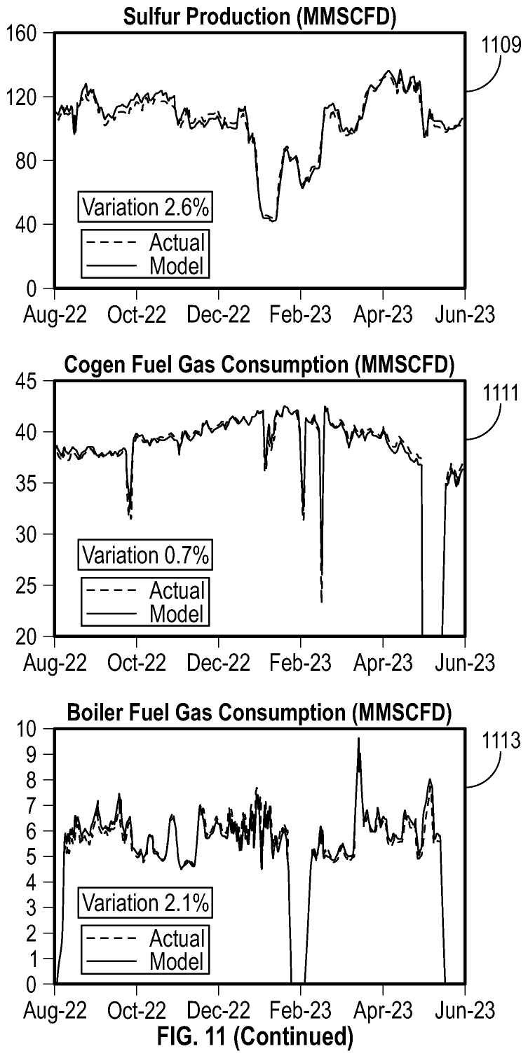

FIG. 11 depicts a set of plots (1101) representing a performance of the AI model used in Step 905 of the method in FIG. 9 and the AI model (707) in the system in FIG. 7. In the set of plots (1101), some process variables outputs from the AI model were computed and compared to actual values for the process variables, as measured in the first example processing plant (100). In plot (1103), a dashed line depicts actual values of the plant output flow rate for the sales gas SG (150) produced by the first example processing plant (100) at a set of timesteps between the dates of August 2022 to June 2023. A solid line depicts predicted values for the plant output flow rate for the sales gas SG (150) at the same time steps. The predicted values for the plant output flow rate for the sales gas SG (150) were computed by the second order polynomial fit in EQ. 1, using, as input, the plant input flow rates for the plant input materials of the first example processing plant (100), namely, the first natural gas (103), second natural gas (106), third natural gas (124), fourth natural gas (127) and gas condensate (129). The abscissa axis represents time. The ordinate axis represents a plant output flow rate for the sales gas SG (150). If the AI model performed perfectly, the solid line would be superimposed on the dashed line. An interpretation of the solid line being close to the dashed line is that the values of the plant output flow rate for the sales gas SG (150) predicted by the AI model are close to the actual values of the plant output flow rate for the sales gas SG (150) produced by the first example processing plant (100).

Plot (1103) further depicts a variation between the actual values of the plant output flow rate for the sales gas SG (150) and the predicted values for the plant output flow rate for the sales gas SG (150). Denoting n as the number of time steps used to plot the plot (1103), tᵢ as the time steps, for i=1, . . . , n, yᵢ as an actual value of the plant output flow rate for the sales gas SG (150) at time tᵢ and ŷᵢ as a predicted value, by the AI model, of the plant output flow rate for the sales gas SG (150) at time tᵢ, the variation in Plot (1103) is defined by

$$\frac{1}{n} {\sum }_{i = 1}^{i = n} {\hat{y}}_{i} / {y}_{i} .$$

In some embodiments, an interpretation of the variation being 2.3% is that the values of the plant output flow rate for the sales gas SG (150) predicted by the AI model are close to the actual values of the plant output flow rate for the sales gas SG (150) produced by the first example processing plant (100).

In plot (1105), a dashed line depicts actual values of the plant output flow rate for the Ethane (152) produced by the first example processing plant (100) at a set of timesteps between the dates of August 2022 to June 2023. A solid line depicts predicted values for the plant output flow rate for the Ethane (152) at the same time steps. The predicted values for the plant output flow rate for the Ethane (152) were computed by the second order polynomial fit in EQ. 2, using, as input, the plant input flow rates for the plant input materials of the first example processing plant (100), namely, the first natural gas (103), second natural gas (106), third natural gas (124), fourth natural gas (127) and gas condensate (129). The abscissa axis represents time. The ordinate axis represents a plant output flow rate for the Ethane (152). If the AI model performed perfectly, the solid line would be superimposed on the dashed line. An interpretation of the solid line being close to the dashed line is that the values of the plant output flow rate for the Ethane (152) predicted by the AI model are close to the actual values of the plant output flow rate for the Ethane (152) produced by the first example processing plant (100).

Plot (1105) further depicts a variation between the actual values of the plant output flow rate for the Ethane (152) and the predicted values for the plant output flow rate for the Ethane (152). Denoting n as the number of time steps used to plot the plot (1105), tᵢ as the time steps, for i=1, . . . , n, yᵢ as an actual value of the plant output flow rate for Ethane (152) at time tᵢ and ŷᵢ as a predicted value, by the AI model, of the plant output flow rate for the Ethane (152) at time tᵢ, the variation in Plot (1105) is defined by

$$\frac{1}{n} {\sum }_{i = 1}^{i = n} {\hat{y}}_{i} / {y}_{i} .$$

In some embodiments, an interpretation of the variation being 2.8% is that the values of the plant output flow rate for the Ethane (152) predicted by the AI model are close to the actual values of the plant output flow rate for the Ethane (152) produced by the first example processing plant (100).

In plot (1107), a dashed line depicts actual values of the plant output flow rate for the NGLs (146) produced by the first example processing plant (100) at a set of timesteps between the dates of October 2022 to June 2023. A solid line depicts predicted values for the plant output flow rate for the NGLs (146) at the same time steps. The predicted values for the plant output flow rate for the NGLs (146) were computed by the second order polynomial fit in EQ. 3, using, as input, the plant input flow rates for the plant input materials of the first example processing plant (100), namely, the first natural gas (103), second natural gas (106), third natural gas (124), fourth natural gas (127) and gas condensate (129). The abscissa axis represents time. The ordinate axis represents a plant output flow rate for the NGLs (146). If the AI model performed perfectly, the solid line would be superimposed on the dashed line. An interpretation of the solid line being close to the dashed line is that the values of the plant output flow rate for the NGLs (146) predicted by the AI model are close to the actual values of the plant output flow rate for the NGLs (146) produced by the first example processing plant (100).

Plot (1107) further depicts a variation between the actual values of the plant output flow rate for the NGLs (146) and the predicted values for the plant output flow rate for the NGLs (146). Denoting n as the number of time steps used to plot the plot (1107), tᵢ as the time steps, for i=1, . . . , n, yᵢ as an actual value of the plant output flow rate for the NGLs (146) at time tᵢ and ŷᵢ as a predicted value, by the AI model, of the plant output flow rate for the NGLs (146) at time ti, the variation in Plot (1107) is defined by

$$\frac{1}{n} {\sum }_{i = 1}^{i = n} {\hat{y}}_{i} / {y}_{i} .$$

In some embodiments, an interpretation of the variation being 3% is that the values of the plant output flow rate for the NGLs (146) predicted by the AI model are close to the actual values of the plant output flow rate for the NGLs (146) produced by the first example processing plant (100).

In plot (1109), a dashed line depicts actual values of the plant output flow rate for the Sulfur (141) produced by the first example processing plant (100) at a set of timesteps between the dates of August 2022 to June 2023. A solid line depicts predicted values for the plant output flow rate for the Sulfur (141) at the same time steps. The predicted values for the plant output flow rate for the Sulfur (141) were computed by the second order polynomial fit in EQ. 4, using, as input, the plant input flow rates for the plant input materials of the first example processing plant (100), namely, the first natural gas (103), second natural gas (106), third natural gas (124), fourth natural gas (127) and gas condensate (129). The abscissa axis represents time. The ordinate axis represents a plant output flow rate for the Sulfur (141). If the AI model performed perfectly, the solid line would be superimposed on the dashed line. An interpretation of the solid line being close to the dashed line is that the values of the plant output flow rate for the Sulfur (141) predicted by the AI model are close to the actual values of the plant output flow rate for the Sulfur (141) produced by the first example processing plant (100).

Plot (1109) further depicts a variation between the actual values of the plant output flow rate for the Sulfur (141) and the predicted values for the plant output flow rate for the Sulfur (141). Denoting n as the number of time steps used to plot the plot (1109), tᵢ as the time steps, for i=1, . . . , n, yᵢ as an actual value of the plant output flow rate for the Sulfur (141) at time tᵢ and ŷᵢ as a predicted value, by the AI model, of the plant output flow rate for the Sulfur (141) at time tᵢ, the variation in Plot (1109) is defined by

$$\frac{1}{n} {\sum }_{i = 1}^{i = n} {\hat{y}}_{i} / {y}_{i} .$$

In some embodiments, an interpretation of the variation being 2.6% is that the values of the plant output flow rate for the Sulfur (141) predicted by the AI model are close to the actual values of the plant output flow rate for the Sulfur (141) produced by the first example processing plant (100).

In plot (1111), a dashed line depicts actual values of the fuel consumed by the cogenerators C1 (169) and C2 (170) at a set of timesteps between the dates of August 2022 to June 2023. A solid line depicts predicted values for the fuel consumed by the cogenerators C1 (169) and C2 (170) at the same time steps. The predicted values for the fuel consumed by the cogenerators C1 (169) and C2 (170) were computed by the second order polynomial fit in EQ. 10, using, as input, the cogenerated steam produced by the first example processing plant (100). The abscissa axis represents time. The ordinate axis represents a fuel consumed by the cogenerators C1 (169) and C2 (170). If the AI model performed perfectly, the solid line would be superimposed on the dashed line. An interpretation of the solid line being close to the dashed line is that the values of the fuel consumed by the cogenerators C1 (169) and C2 (170) predicted by the AI model are close to the actual values of the fuel consumed by the cogenerators C1 (169) and C2 (170). Plot (1111) further depicts a variation between the actual values of the fuel consumed by the cogenerators C1 (169) and C2 (170) and the predicted values for the fuel consumed by the cogenerators C1 (169) and C2 (170). Denoting n as the number of time steps used to plot the plot (1111), tᵢ as the time steps, for i=1, . . . , n, yᵢ as an actual value of the fuel consumed by the cogenerators C1 (169) and C2 (170) at time tᵢ and ŷᵢ as a predicted value, by the AI model, of the fuel consumed by the cogenerators C1 (169) and C2 (170) at time tᵢ, the variation in Plot (1111) is defined by

$$\frac{1}{n} {\sum }_{i = 1}^{i = n} {\hat{y}}_{i} / {y}_{i} .$$

In some embodiments, an interpretation of the variation being 0.7% is that the values of the fuel consumed by the cogenerators C1 (169) and C2 (170) predicted by the AI model are close to the actual values of the fuel consumed by the cogenerators C1 (169) and C2 (170).

In plot (1113), a dashed line depicts actual values of the fuel consumed by the boilers B1 (165), B2 (166), B3 (167) and B4 (168) at a set of timesteps between the dates of August 2022 to June 2023. A solid line depicts predicted values for the fuel consumed by the boilers B1 (165), B2 (166), B3 (167) and B4 (168) at the same time steps. The predicted values for the fuel consumed by the boilers B1 (165), B2 (166), B3 (167) and B4 (168) were computed by the second order polynomial fit in EQ. 6, using, as input, the processing steam produced by the boilers. The abscissa axis represents time. The ordinate axis represents a fuel consumed by the boilers B1 (165), B2 (166), B3 (167) and B4 (168). If the AI model performed perfectly, the solid line would be superimposed on the dashed line. An interpretation of the solid line being close to the dashed line is that the values of the fuel consumed by the boilers B1 (165), B2 (166), B3 (167) and B4 (168) predicted by the AI model are close to the actual values of the fuel consumed by the boilers B1 (165), B2 (166), B3 (167) and B4 (168).

Plot (1113) further depicts a variation between the actual values of the fuel consumed by the boilers B1 (165), B2 (166), B3 (167) and B4 (168) and the predicted values for the fuel consumed by the boilers B1 (165), B2 (166), B3 (167) and B4 (168). Denoting n as the number of time steps used to plot the plot (1113), tᵢ as the time steps, for i=1, . . . , n, yᵢ as an actual value of the fuel consumed by the boilers B1 (165), B2 (166), B3 (167) and B4 (168) at time tᵢ and ŷᵢ as a predicted value, by the AI model, of the fuel consumed by the boilers B1 (165), B2 (166), B3 (167) and B4 (168) at time ti, the variation in Plot (1113) is defined by

$$\frac{1}{n} {\sum }_{i = 1}^{i = n} {\hat{y}}_{i} / {y}_{i} .$$

In some embodiments, an interpretation of the variation being 0.7% is that the values of the fuel consumed by the boilers B1 (165), B2 (166), B3 (167) and B4 (168) predicted by the AI model are close to the actual values of the fuel consumed by the boilers B1 (165), B2 (166), B3 (167) and B4 (168).

Table I features examples of minimum and maximum processor input flow rates for some material processors of the first example processing plant (100). The left column in Table I shows a list of material processors from the first example processing plant (100), as explained in FIG. 1. The middle column in Table I shows the minimum processor input flow rate allowed for a processor input material to be received by for each material processor from the left column. The right column in Table I shows the maximum processor input flow rate allowed for a processor input material to be received by for each material processor from the left column.

TABLE I
Minimum and maximum processor input flow rates for some material
processors of the first example processing plant (100).

| Material | Minimum processor input | | Maximum processor input | |
|---|---|---|---|---|
| processor | flow rate | | flow rate | |
| HP1, HP2 | 150 | MMSCFD | 360 | MMSCFD |
| LP1, LP2, LP3 | 120 | MMSCFD | 180 | MMSCFD |
| LP4 | 140 | MMSCFD | 250 | MMSCFD |
| S1, S2 | 18 | MMSCFD | 32 | MMSCFD |
| S3 | 18 | MMSCFD | 35 | MMSCFD |
| S4, S5 | 20 | MMSCFD | 45 | MMSCFD |
| TEG | 150 | MMSCFD | 520 | MMSCFD |
| E1, E2 | 250 | MMSCFD | 650 | MMSCFD |
| B1, B2 | 150 | MPPH | 400 | MPPH |
| B3, B4 | 80 | MPPH | 500 | MPPH |
| C1, C2 (steam) | 450 | MPPH | 800 | MPPH |

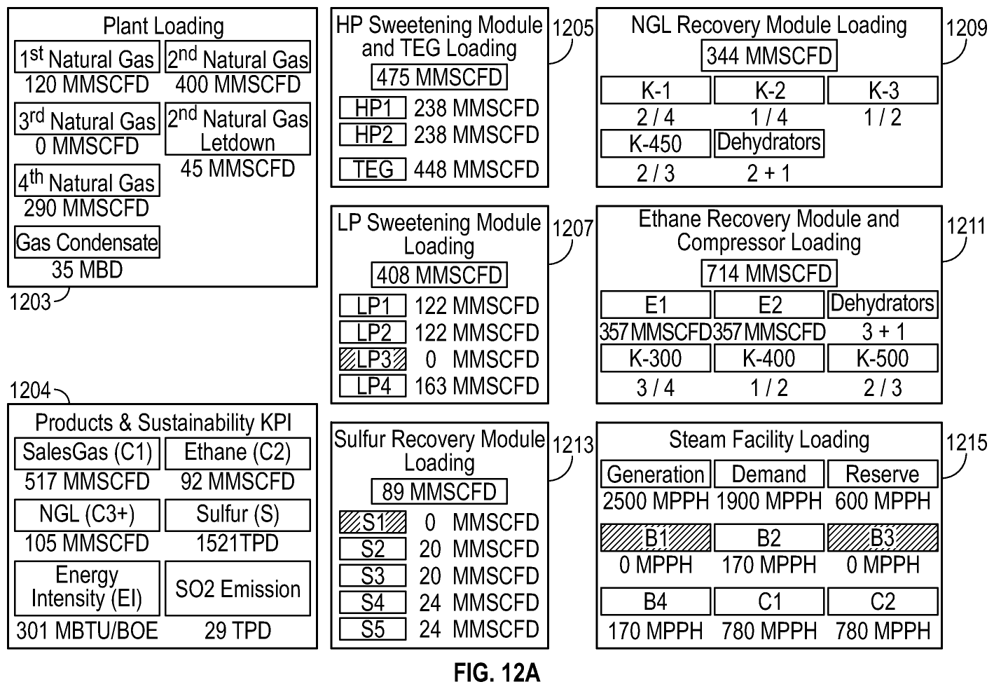

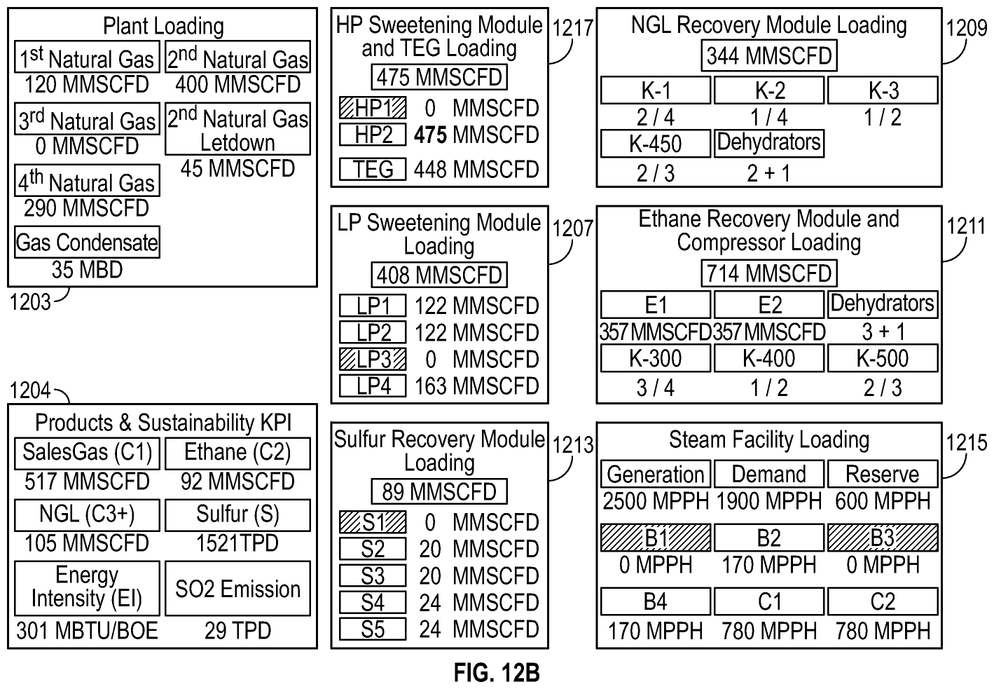

FIG. 12A depicts an example result of the AI model described herein applied to the first example processing plant (100), in accordance with one or more embodiments. The AI model is described as the AI model (707) in the system in FIG. 7 and the AI model in Step 905 in the method in FIG. 9. A first tabulated dataset (1203) shows the plant input flow rates for the plant input materials. The plant input flow rate for the first natural gas (103) is 120 MMSCFD; the plant input flow rate for the second natural gas (106) is 400 MMSCFD, distributed as 355 MMSCFD going into the HP sweetening module (105) and 45 MMSCFD going into the LP sweetening module (126); the plant input flow rate for the third natural gas (124) is 0 MMSCFD (i.e., no third natural gas (124) is received by the first example processing plant (100)); the plant input flow rate for the fourth natural gas (127) is 290 MMSCFD; the plant input flow rate for the gas condensate (129) is 35 MBD.

A second tabulated dataset (1204) shows the plant output flow rates for the plant output materials from the first example processing plant (100). The plant output flow rates are computed by the polynomial fits of EQ. 1 to EQ. 4 of the AI model that receives, as input, the plant input flow rates from the first tabulated dataset (1203) and the process flow of the first example processing plant (100). The second tabulated dataset (1204) shows a plant output flow rate of 517 MMSCFD for the sales gas SG (150), 92 MMSCFD for the Ethane (152), 105 MMSCFS for the NGLs (146) and 1521 TPD for the Sulfur (141). The second tabulated dataset (1204) further shows sustainability indicators, also computed by the AI model from the plant input flow rates from the first tabulated dataset (1203) and the process flow of the first example processing plant (100). The sustainability indicators are a maximum cogenerated power (called an energy intensity in FIG. 12B) of 310 MBTU/BOE, produced by the cogenerators C1 (169) and C2 (170), and a sulfur dioxide (SO₂) emission of 29 TPD.

A third tabulated dataset (1205) shows processor input flow rates for the material processors within the HP sweetening module (105) computed by the AI model that receives, as input, the plant input flow rates from the first tabulated dataset (1203) and the process flow of the first example processing plant (100). The third tabulated dataset (1205) further shows a total processor input flow rates for the HP sweetening module (105), equal to the sum of the processor input flow rates for all the material processors within the HP sweetening module (105). Each of the gas sweeteners HP1 (108) and HP2 (109) receives a processor input flow rate of 238 MMSCFD. The sum of the processor input flow rates for the gas sweeteners HP1 (108) and HP2 (109) is equal to the total processor input flow rate for the HP sweetening module (105): 475 MMSCFD. It is noted that for display purposes, values of input and output flow rates are rounded to the nearest integer in FIG. 12A. The input flow rate into each of the gas sweeteners HP1 (108) and HP2 (109) is rounded to 238 MMSCFD. To obtain the total processor input flow rate of 475 MMSCFD for the HP sweetening module (105), the actual, non-rounded input flow rates for the gas sweeteners HP1 (108) and HP2 (109) are summed, then rounded. Therefore, although the sum 238+238, of the displayed input flow rates for the gas sweeteners HP1 (108) and HP2 (109), equals 476, the total processor input flow rate into the HP sweetening module (105) is correctly displayed as 475 MMSCFD. For example, in some embodiments, the actual input flow rate into each of the gas sweeteners HP1 (108) and HP2 (109) is 237.6 MMSCFD, totaling a total processor input flow rate of 475.2 MMSCFD into the HP sweetening module (105). In FIG. 12A, rounded up values of 238 MMSCFD are displayed for the input flow rate into each of the gas sweeteners HP1 (108) and HP2 (109). In FIG. 12A, a rounded down value of 475 MMSCFD is displayed for the total processor input flow rate into the HP sweetening module (105). As expected, the total of 475 MMSCFD is the sum of the plant input flow rates for the first natural gas (103), set to 120 MMSCFD in the first tabulated dataset (1203) and the portion of the second natural gas (106) distributed to the HP sweetening module (105), set to 355 MMSCFD in the first tabulated dataset (1203). The third tabulated dataset (1205) further shows a processor input flow rate of 448 MMSCFD for the TEG dehydration module (111), also computed by the AI model. Notice that the processor input flow rate for the TEG dehydration module (111) is less than the total processor input flow rates for the HP sweetening module (105) by 37 MMSCFD. This may indicate that a processor output flow rate of 37 MMSCFD of acid gas was sent from the HP sweetening module (105) to the Sulfur recovery module (118).

A fourth tabulated dataset (1207) shows a total processor input flow rate for the LP sweetening module (126), equal to 408 MMSCFD, and processor input flow rates for the material processors within the LP sweetening module (126). It is noted that according to Table I, the gas sweeteners LP1 (132), LP2 (133) and LP3 (134) each have a minimum processor input flow rate of 120 MMSCFD and a maximum processor input flow rate of 180 MMSCFD. It is further noted that the gas sweetener LP4 (135) has a minimum processor input flow rate of 140 MMSCFD and a maximum processor input flow rate of 250 MMSCFD. Therefore, the total processor input flow rates for the LP sweetening module (126), equal to 408 MMSCFD, can be processed by three of the four gas sweeteners within the LP sweetening module (126). Using the system in FIG. 7, the performance (733) is optimized by turning off the gas sweetener LP3 (134), preventing the gas sweetener LP3 (134) from consuming energy. Turning off the gas sweetener LP3 (134) to reduce the energy consumption of the first example processing plant (100) is a process flow adjustment as part of the adjustments (735) in FIG. 7. The total processor input flow rate for the LP sweetening module (126), equal to 408 MMSCFD, is distributed as 122 MMSCFD going into the gas sweeteners LP1 (132), 122 MMSCFD going into the gas sweeteners LP2 (133) and 163 MMSCFD going into the gas sweeteners LP4 (135). The processor input flow rate going into each of the sweeteners LP1 (132), LP2 (133) and LP4 (135) is determined by the AI model.

A fifth tabulated dataset (1209) shows a total processor input flow rates for the NGL recovery module (137), equal to 344 MMSCFD, computed by the AI model. The total processor input flow rate for the NGL recovery module (137) is the sum of the processor input flow rates for all of the material processors within the NGL recovery module (137). The processor input flow rates for all of the material processors within the NGL recovery module (137) are computed by the AI model but are not displayed in the fifth tabulated dataset (1209). The NGL recovery module (137) includes four compressors of a first compressor type denoted as K1, four compressors of a second compressor type denoted as K2, two compressors of a third compressor type denoted as K3 and three compressors of fourth compressor type denoted as K-450. The fifth tabulated dataset (1209) shows that according to the process flow of the first example processing plant (100), two out of four type-K1 compressors are in use, one out of four type-K2 compressors is in use, one out of two type-K3 compressors is in use and two out of three type-K-450 compressors are in use. The NGL recovery module (137) further includes two dehydrators. the fifth tabulated dataset (1209) further shows that the two dehydrators are in use, and that the NGL recovery module (137) makes further use of a third dehydrator that is external to the NGL recovery module (137).

A sixth tabulated dataset (1211) shows a total processor input flow rates for the Ethane recovery module (113), equal to 714 MMSCFD. The total processor input flow rate for the Ethane recovery module (113) is the sum of the processor input flow rates for the separators E1 (114), of 357 MMSCFD, and E2 (115), of 357 MMSCFD, both computed by the AI model. The Ethane recovery module (113) includes three dehydrators. The sixth tabulated dataset (1211) further shows that the three dehydrators are in use, and that the Ethane recovery module (113) makes further use of a fourth dehydrator that is external to the Ethane recovery module (113). The sixth tabulated dataset (1211) further shows the use of a system of compressors, connected to the Ethane recovery module (113). The system of compressors includes four compressors of a fifth compressor type denoted as K-300, two compressors of a sixth compressor type denoted as K-400, and three compressors of a seventh compressor type denoted as K-500. The sixth tabulated dataset (1211) shows that according to the process flow of the first example processing plant (100), three out of four type-K-300 compressors are in use, one out of two type-K-400 compressors is in use and two out of three type-K-500 compressors are in use.

A seventh tabulated dataset (1213) shows a total processor input flow rates for the Sulfur recovery module (118), equal to 89 MMSCFD. According to Table I, the total processor input flow rates for the Sulfur recovery module (118), of 89 MMSCFD, can be processed by four of the five SRUs S1 (119), S2 (120), S3 (121), S4 (122) and S5 (123) within the Sulfur recovery module (118). In that regard, the performance of the first example processing plant (100) is optimized by turning off the sulfur recovery unit S1 (119) in the process flow of the first example processing plant (100). Turning off the sulfur recovery unit S1 (119) prevents the sulfur recovery unit S1 (119) from consuming energy. The processor input flow rates within the sulfur recovery units, S2 (120), S3 (121), S4 (122) and S5 (123) are computed by the AI model, as 20 MMSCFD, 20 MMSCFD, 24 MMSCFD, and 24 MMSCFD, respectively. The total processor input flow rate for the Sulfur recovery module (118), equal to 89 MMSCFD, is the sum of the processor input flow rates within the sulfur recovery units, S2 (120), S3 (121), S4 (122) and S5 (123).

An eighth tabulated dataset (1215) shows the production of steam by the steam facility (162). The eighth tabulated dataset (1215) shows a first required steam production rate of 1900 MPPH, required by the first example processing plant (100) to process the plant input material at the plant input flow rates from the first tabulated dataset (1203) according to the process flow of the first example processing plant (100). As stated in the description the system in FIG. 7, the first required steam production rate is computed by the AI model. According to Table I, the first required steam production rate for the steam facility (162), of 1900 MPPH, can be produced by the two cogenerators C1 (169) and C2 (170), and two of the four boilers B1 (165), B2 (166), B3 (167) and B4 (168) within the steam facility (162). In that regard, the performance of the first example processing plant (100) is optimized by turning off the boilers B1 (165) and B3 (167). Turning off the boilers B1 (165) and B3 (167) prevents the boilers B1 (165) and B3 (167) from consuming energy. The steam production rates for the cogenerators C1 (169) and C2 (170) are computed by the AI model, as 780 MPPH for the cogenerator C1 (169) and 780 MPPH for the cogenerator C2 (170), fulfilling 1560 MPPH of the first required steam production rate of 1900 MPPH. The remaining 340 MPPH, from the first required steam production rate of 1900 MPPH, are fulfilled by the boilers B2 (166) and B4 (168). In that regard, a steam production rate of 170 MPPH is computed by the AI model for the boiler B2 (166) and a steam production rate of 170 MPPH is computed by the AI model for the boiler B4 (168). The eighth tabulated dataset (1215) further shows a maximum capacity of 2500 MPPH, called “Generation”, that can be generated by the steam facility (162) whenever needed. Since the steam facility (162) is optimized to only produce steam at the first required steam production rate of 1900 MPPH, there is an unused capacity of 600 MPPH by the steam facility (162). The unused capacity, called “Reserve” in the eighth tabulated dataset (1215), is equal to a difference between the maximum capacity of 2500 MPPH and the first required steam production rate of 1900 MPPH.

FIG. 12B shows an example of running the AI model by modifying the process flow used in FIG. 12A. FIG. 12B includes the tables (1203), (1204), (1207), (1209), (1211), (1213) and (1215) from FIG. 12A. FIG. 12B further includes a ninth tabulated dataset (1217). In a similar fashion as in FIG. 12A, values of input and output flow rates are rounded to the nearest integer in FIG. 12B. The ninth tabulated dataset (1217) shows the processor input flow rates into the material processors within the HP sweetening module (105), obtained by the AI model, after the gas sweetener HP1 (108) has been turned off, or becomes unavailable for a technical reason, such as a breakdown. According to the process flow of the first example processing plant (100), a total processor input flow rate of 475 MMSCFD is still input into the HP sweetening module (105). However, since the gas sweetener HP1 (108) has been turned off, the AI model determines that the total processor input flow rate of 475 MMSCFD must be input into the only HP gas sweetener available, which is the HP gas sweetener HP2 (109). From Table I, the maximum processor input flow rate for the HP gas sweetener HP2 (109) is 360 MMSCFD. Consequently, there is an overflow of 115 MMSCFD in the HP gas sweetener HP2 (109). The fact that there is an overflow in the HP gas sweetener HP2 (109) is depicted by the processor input flow rate of 475 MMSCFD into the HP gas sweetener HP2 (109) being filled with diagonal line patterns in the ninth tabulated dataset (1217). In one or more embodiments, the overflow of 115 MMSCFD into the HP gas sweetener HP2 (109) leads to an opportunity loss of the first example processing plant (100), as 115 MMSCFD worth of plant input material must be put on hold. In this scenario, the performance of the first example processing plant (100) may be optimized. The processor input flow rate of 475 MMSCFD going into the HP gas sweetener HP2 (109) includes 120 MMSCFD of first natural gas (103) and 355 MMSCFD of second natural gas (106). An example of optimization of the first example processing plant (100) having an overflow in the HP gas sweetener HP2 (109) is to make a process flow adjustment. The process flow adjustment includes deviating 115 MMSCFD of second natural gas (106) from the HP sweetening module (105) to the LP sweetening module (126). By doing so, the gas sweetener HP2 (109) only receives a processor input flow rate of 360 MMSCFD, which is not an overflow. The 115 MMSCFD of second natural gas (106) can be deviated from the HP sweetening module (105) to the LP sweetening module (126) by limiting a maximum flow of second natural gas (106) within the line (107) to 240 MMSCFD and allowing for an extra flow of 115 MMSCFD of second natural gas (106) within the line (131). In some embodiments, limiting the maximum flow of second natural gas (106) within the line (107) is done by reducing an opening of a first valve. In some embodiments allowing for an extra flow of second natural gas (106) within the line (131) is done by increasing an opening of a second valve. After the process flow adjustment, the AI model may be used to re-compute the plant output flow rates and the sustainability indicators in the second tabulated dataset (1204), the processor input flow rates in Tables (1205), (1207), (1209), (1211) and (1213), and the steam production rates in the eighth tabulated dataset (1215). It is noted that an additional processor input flow rate of 115 MMSCFD in the LP sweetening module (126) can still be processed by the gas sweeteners LP1 (132), LP2 (133) and LP4 (135), so there is no need to turn on the gas sweeteners LP3 (134). By adding a processor input flow rate of 115 MMSCFD into the LP sweetening module (126), the total processor input flow rate for the LP sweetening module (126) becomes 523 MMSCFD, which is less than a total maximum processor input flow rate of 610 MMSCFD, from Table I, for the gas sweeteners LP1 (132), LP2 (133) and LP4 (135) combined.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining an input flow rate for each input material within a set of input materials received by a processing plant, wherein the processing plant:
comprises one or more material processors connected according to a process flow, and
outputs a set of output materials;
determining, using an artificial intelligence (AI) model, a set of process variables, based on the process flow and the input flow rate for each input material within the set of input materials, wherein the set of process variables comprises a first output flow rate for a first output material within the set of output materials;
determining a performance of the processing plant, based on the set of process variables; and
optimizing the performance of the processing plant, wherein optimizing the performance comprises increasing the first output flow rate by adjusting the input flow rate for one or more input materials within the set of input materials.

2. The method of claim 1, wherein:
the set of input materials comprises natural gas; and
the set of output materials comprises one or more of:
sales gas, the sales gas comprising methane,
ethane,
sulfur, and
a natural gas liquid (NGL).

3. The method of claim 2, wherein the one or more material processors comprise one or more of:
a gas feeder;
a gas sweetener;
a gas condensate stripper;
a fractionation column;
a cooler;
a compressor;
a dehydrator;
a triethylene glycol (TEG) gas dehydrator;
a heat recovery steam generator; and
a boiler.

4. The method of claim 1:
wherein the one or more material processors comprises a first material processor that receives, at least, a first input material of the set of input materials;
wherein the set of process variables further comprises a first input flow rate for the first input material;
wherein the method further comprises:
obtaining a first maximum input flow rate for the first input material, and
making a determination whether the first input flow rate is greater than the first maximum input flow rate; and
wherein optimizing the performance further comprises, in response to the determination that the first input flow rate is greater than the first maximum input flow rate, diverting some of the first input material to another material processor within the one or more material processors.

5. The method of claim 1:
wherein the one or more material processors comprises a first material processor that receives, at least, a first input material of the set of input materials;
wherein the performance is further based on an energy consumption of the one or more material processors;
wherein optimizing the performance further comprises inactivating the first material processor to prevent the prevent material processor from consuming energy; and
wherein the method further comprises re-routing the first input material to another material processor within the one or more material processors.

6. The method of claim 1, wherein:
the processing plant makes use of processing steam at a first required steam production rate, the first required steam production rate based on the process flow and the input flow rate for each input material within the set of input materials;
the processing plant further comprises a steam facility that consumes fuel and produces processing steam at a first steam production rate;
the set of process variables further comprises the first required steam production rate and a first predicted fuel consumption required by the steam facility to produce processing steam at the first required steam production rate;
the performance is further based on a first fuel consumption by the steam facility; and
optimizing the performance further comprises, upon determining that the first steam production rate is greater than the first predicted steam production rate, setting the first steam production rate to be equal to the first predicted steam production rate in order to cap the first fuel consumption by the first predicted fuel consumption.

7. The method of claim 6, wherein:
the processing plant consumes utility power;
the steam facility includes a cogenerator that produces cogenerated steam at a cogenerated steam production rate;
the set of process variables further includes a maximum cogenerated steam production rate by the cogenerator;
the cogenerator further produces cogenerated power using some of the cogenerated steam; and
optimizing the performance further comprises, upon determining that the maximum cogenerated steam production rate is greater than a steam production rate needed to produce cogenerated power equating the utility power, using some of the cogenerated steam as processing steam.

8. The method of claim 7, wherein the performance is further based on an operating revenue of the processing plant, the operating revenue based on:
a cost of each input material within the set of input materials;
a cost from an energy consumed by each of the one or more material processors;
a cost of fuel consumed by the steam facility; and
a revenue from each output material within the set of output materials.

9. The method of claim 1, wherein the AI model comprises a polynomial fit.

10. The method of claim 9, further comprising:
conducting a plurality of training operations for the processing plant, each training operation comprising:
inputting the set of input materials to the processing plant, each material within the set of input materials input with a distinct input flow rate;
recording, for each training operation, an output flow rate for the first output material;
constructing a training dataset of training examples, wherein each training example comprises:
for a training operation, the flow rate for each input material within the set of input materials, and
the first output flow rate recorded for the training operation; and
training the AI model using the training dataset, the AI model configured to receive, as input, the input flow rate for each input material within the set of input materials, and return, as output, the first output flow rate for the first output material.

11. A system, comprising:
a process flow;
a processing plant, comprising one or more material processors connected by the process flow, wherein the processing plant:
receives a set of input materials, and
outputs a set of output materials;
a computer, configured to:
receive an input flow rate for each input material within a set of input materials;
determine, using an artificial intelligence (AI) model, a set of process variables, based on the process flow and the input flow rate for each input material within the set of input materials, wherein the set of process variables comprises a first output flow rate for a first output material within the set of output materials;
determine a performance of the processing plant, based on the set of process variables; and
optimize the performance of the processing plant, wherein optimizing the performance comprises increasing the first output flow rate by adjusting the input flow rate for one or more input materials within the set of input materials.

12. The system of claim 11, wherein:
the set of input materials comprises natural gas; and
the set of output materials comprises one or more of:
sales gas, the sales gas comprising methane,
ethane,
sulfur, and
a natural gas liquid (NGL).

13. The system of claim 12, wherein the one or more material processors comprise one or more of:
a gas feeder;
a gas sweetener;
a gas condensate stripper;
a fractionation column;
a cooler;
a compressor;
a dehydrator;
a triethylene glycol (TEG) gas dehydrator;
a heat recovery steam generator; and
a boiler.

14. The system of claim 11:
wherein the one or more material processors comprises a first material processor that receives, at least, a first input material of the set of input materials;
wherein the set of process variables further comprises a first input flow rate for the first input material;
wherein the computer is further configured to:
obtain a first maximum input flow rate for the first input material, and
make a determination whether the first input flow rate is greater than the first maximum input flow rate; and
wherein optimizing the performance further comprises, in response to the determination that the first input flow rate is greater than the first maximum input flow rate, diverting some of the first input material to another material processor within the one or more material processors.

15. The system of claim 11:
wherein the one or more material processors comprises a first material processor that receives, at least, a first input material of the set of input materials;
wherein the performance is further based on an energy consumption of the one or more material processors;
wherein optimizing the performance further comprises inactivating the first material processor to prevent the prevent material processor from consuming energy; and
wherein the computer is further configured to re-route the first input material to another material processor within the one or more material processors.

16. The system of claim 11, wherein:
the processing plant makes use of processing steam at a first required steam production rate, the first required steam production rate based on the process flow and the input flow rate for each input material within the set of input materials;
the processing plant further comprises a steam facility that consumes fuel and produces processing steam at a first steam production rate;
the set of process variables further comprises the first required steam production rate and a first predicted fuel consumption required by the steam facility to produce processing steam at the first required steam production rate;
the performance is further based on a first fuel consumption by the steam facility; and
optimizing the performance further comprises, upon determining that the first steam production rate is greater than the first predicted steam production rate, setting the first steam production rate to be equal to the first predicted steam production rate in order to cap the first fuel consumption by the first predicted fuel consumption.

17. The system of claim 16, wherein:
the processing plant consumes utility power;
the steam facility includes a cogenerator that produces cogenerated steam at a cogenerated steam production rate;
the set of process variables further includes a maximum cogenerated steam production rate by the cogenerator;
the cogenerator further produces cogenerated power using some of the cogenerated steam; and
optimizing the performance further comprises, upon determining that the maximum cogenerated steam production rate is greater than a steam production rate needed to produce cogenerated power equating the utility power, using some of the cogenerated steam as processing steam.

18. The system of claim 17, wherein the performance is further based on an operating revenue of the processing plant, the operating revenue based on:
a cost of each input material within the set of input materials;
a cost from an energy consumed by each of the one or more material processors;
a cost of fuel consumed by the steam facility; and
a revenue from each output material within the set of output materials.

19. The system of claim 11, wherein the AI model comprises a polynomial fit.

20. The system of claim 19, wherein the computer is further configured to:
receive results of a plurality of training operations for the processing plant, each training operation comprising:
inputting the set of input materials to the processing plant, each material within the set of input materials input with a distinct input flow rate;
recording, for each training operation, an output flow rate for the first output material;
construct a training dataset of training examples, wherein each training example comprises:
for a training operation, the flow rate for each input material within the set of input materials, and
the first output flow rate recorded for the training operation; and
train the AI model using the training dataset, the AI model configured to receive, as input, the input flow rate for each input material within the set of input materials, and return, as output, the first output flow rate for the first output material.
